SEQUENCE LISTING (13 sequences)

SEQ ID NO: 1 - protein, 714 aa, Aspergillus niger
QCPYLSGEMSFTQEQDNAGDTIEVTEQPIDNTLYVNDTGSYMTTDFGTPISDQTSLKAGPRGPTLLEDFIFRQKLQRFDHERVPERVVHARGAGAYGTFKSYADWSNVTAADFLSANDKETPMFCRFSTVVGFRGSVDTARDVHGHACRFYTDEGNYDIVGINFAPFFIQDAIQFPDLVHAIKPMPNNEIPQAATAHTSAWDFFSQQSTALHSALWLMSGNGIPRSFRHMNGYGVHSFRFVAANGTSKVVRYRWKSQQGVASLVWDEAQAAAGKNSDYHRQDLYNAIANGHYPKYELQAQIMDEADMLRFGFDLLDPTKLVPEEVVPYTPLGMMELNANPTNYFAEVEQAGFQPGHVVPGIDFTDDPLLQGRLFSYLDTQLTRHGGPNFEQIPVNRPRKPVHNNNRDGFGQQQIPTNNWAYTPNSMSNGYPMQANQTQGHGFFTAPYRYASGHLVRQTSPTFNDHWSQPAMFWNSLIPAEQQMVVNAIVFENSKVNSPHVRKNVVNQLNMVNNNLAVRVARGLGLDEPSPNPTYYTSNKTSNVGTFGKPLLSIEGLQVGFLASNSHPESIKQGQAMAAQFSAAGVDLNIVTEAYADGVNTTYALSDAIDFDALIIADGVQSLFASPALANQMNSTATSTLYPPARPFQILVDSFRYGKPVAAVGSGSVALKNAGIDSSRSGVYTGSSETTEKIAKEVLEGLYTFRFVDRFALDE

SEQ ID NO: 2 - protein, 730 aa, Aspergillus niger
  REGION 1..25: note = Potential truncated N-terminal region cleaved off
MRHFWLLPAVAGIAGAQCPYLSGEMSFTQEQDNAGDTIEVTEQPIDNTLYVNDTGSYMTTDFGTPISDQTSLKAGPRGPTLLEDFIFRQKLQRFDHERVPERVVHARGAGAYGTFKSYADWSNVTAADFLSANDKETPMFCRFSTVVGFRGSVDTARDVHGHACRFYTDEGNYDIVGINFAPFFIQDAIQFPDLVHAIKPMPNNEIPQAATAHTSAWDFFSQQSTALHSALWLMSGNGIPRSFRHMNGYGVHSFRFVAANGTSKVVRYRWKSQQGVASLVWDEAQAAAGKNSDYHRQDLYNAIANGHYPKYELQAQIMDEADMLRFGFDLLDPTKLVPEEVVPYTPLGMMELNANPTNYFAEVEQAGFQPGHVVPGIDFTDDPLLQGRLFSYLDTQLTRHGGPNFEQIPVNRPRKPVHNNNRDGFGQQQIPTNNWAYTPNSMSNGYPMQANQTQGHGFFTAPYRYASGHLVRQTSPTFNDHWSQPAMFWNSLIPAEQQMVVNAIVFENSKVNSPHVRKNVVNQLNMVNNNLAVRVARGLGLDEPSPNPTYYTSNKTSNVGTFGKPLLSIEGLQVGFLASNSHPESIKQGQAMAAQFSAAGVDLNIVTEAYADGVNTTYALSDAIDFDALIIADGVQSLFASPALANQMNSTATSTLYPPARPFQILVDSFRYGKPVAAVGSGSVALKNAGIDSSRSGVYTGSSETTEKIAKEVLEGLYTFRFVDRFALDE

SEQ ID NO: 3 - protein, 583 aa, Aspergillus niger
SNGIEASLLTDPKDVSGRTVDYIIAGGGLTGLTTAARLTENPNISVLVIESGSYESDRGPIIEDLNAYGDIFGSSVDHAYETVELATNNQTALIRSGNGLGGSTLVNGGTWTRPHKAQVDSWETVFGNEGWNWDNVAAYSLQAERARAPNAKQIAAGHYFNASCHGVNGTVHAGPRDTGDDYSPIVKALMSAVEDRGVPTKKDFGCGDPHGVSMFPNTLHEDQVRSDAAREWLLPNYQRPNLQVLTGQYVGKVLLSQNGTTPRAVGVEFGTHKGNTHNVYAKHEVLLAAGSAVSPTILEYSGIGMKSILEPLGIDTVVDLPVGLNLQDQTTATVRSRITSAGAGQGQAAWFATFNETFGDYSEKAHELLNTKLEQWAEEAVARGGFHNTTALLIQYENYRDWIVNHNVAYSELFLDTAGVASFDVWDLLPFTRGYVHILDKDPYLHHFAYDPQYFLNELDLLGQAAATQLARNISNSGAMQTYFAGETIPGDNLAYDADLSAWTEYIPYHFRPNYHGVGTCSMMPKEMGGVVDNAARVYGVQGLRVIDGSIPPTQMSSHVMTVFYAMALKISDAILEDYASMQ

SEQ ID NO: 4 - protein, 307 aa, Trichoderma reesei
MAEKPLHLDLIDTLKDVSVRVDHVRPSHAKGVFVIGSFTPTKEAGQLSTAPHFNSPSTPVVARFSLFTGFPDLPSNDPQAVPHGLAVRFLIGDGVKSDIVCHSTPLFPANTGEGVLAVFKALRDNIVEEYLSTHPEAIPFFTEDRKTPEHWGTQTFYSINAFKFVNAEGKSVFVRYRWVPVAGRHFLTEKELEAKGPNFLFNELPEVFAKGPIIFKLVAQVAEEGDVTGDCMQRWPEDRKLVELGELKLTRVADKQDLPPQKEAISYNVIPGVPGIEPSDDPIIATRGKVYATSGQTRRAAEIEAEA

SEQ ID NO: 5 - protein, 594 aa, Trichoderma reesei
MVPSRRILVTLALVAAPWPPQVLASSTDSYDYIIVGAGTCGLLLANRLSQDANYTVAIIDPGADERDNPNVVDPLGWLGLTGTSVYWNYSSIPQEKLGGRVLEYDAGRGIGGTSLINGMTYIRGDKAQFDAWEQLGNPGWNWTTMLKHFKKIEQFFPPLPWQETAGALYEDEYHGTSGEMHVGFNPALLSGSFYGDVKASWAALGQTLNRDASSGDTAGFDVWPQTLDPVKNVRWDAATAFYWPVQDRPNLALLNGTVSRILWKNDEADVPEASGVEYLTPDGNIKTVNARREVILSAGALRTPLILELSGIGNPSILNGLGIETVVNSPGVGENLIDQSNVALTYSTKESFPGYAPYATFVNATSLFGDGVEALAASTKKSLPIWAQQIAAQTNGVISARAIEHRLQVQHDLIFKKGVTIAEILSSASGTTAISAYWDTLPFSRGSVHLSSANDINTPAINPRFLSVDFDLAVQVAVGRLATKFWTTAPISAVIEARVDPNSTILPDNATDAQWEDFTRSSLISNSHSLGTAAMMKREWGGVVDSQMRVYGTGNVRVVDASVLPMQVSGHLTATLYAVAERAGEMIVGDRSGL

SEQ ID NO: 6 - protein, 524 aa, Aspergillus niger
MQTFGAFLVSFLAASGLAAAARPRLVPKPISRPASSKSAATTGEAYFEQLLDHHNPEKGTFSQRYWWSTEYWGGPGSPVVLFNPGEVSADGYEGYLTNDTLTGVYAQEIQGAVILIEHRYWGDSSPYEVLNAETLQYLTLDQSILDMTYFAETVKLQFDNSSRSNAQNAPWVMVGGSYSGALTAWTESIAPGTFWAYHATSAPVEAIYDFWQYFYPIQQGMAQNCSKDVSLVAEYVDKIGKNGTAKEQQELKELFGLGAVEHYDDFAAVLPNGPYLWQDNDFVTGYSSFFQFCDAVEGVEAGAAVTPGPEGVGLEKALANYANWFNSTILPNYCASYGYWTDEWSVACFDSYNASSPIFTDTSVGNPVDRQWEWFLCNEPFFWWQDGAPEGTSTIVPRLVSASYWQRQCPLYFPEVNGYTYGSAKGKNSATVNSWTGGWDMTRNTTRLIWTNGQYDPWRDSGVSSTFRPGGPLVSTANEPVQIIPGGFHCSDLYMEDYYANEGVRKVVDNEVKQIKEWVEEYYA

SEQ ID NO: 7 - protein, 527 aa, Aspergillus transmontanensis
MQFLPPLSIVTLLASWPSLSRAIHPPRPVPPPVSRPVSTQSLAVEGNATFEQLLDHHDSSKGTFSQRYWWSTEYWGGPGSPVVLFTPGEASADGYEGYLTNNTLTGLYAQEIQGAVILIEHRYWGDSSPYEELTAETLQYLTLEQSILDLTHFAETVQLEFDTSNSSNAPKAPWVLVGGSYSGALAAWTAAVAPETFWAYHATSAPVQAIDDFWQYFDPIRHGMAPNCSRDVSLVANHIDTVGKNGSAADQFALKELFGLEALEHYDDFAAALPTGPYLWQSNTFVTGYSDFFAFCDAVENVEAGAAVVPGPEGVGLQKALTGYANWFNSTILPGYCASYGYWTDNRTVACFDTHNPSSAIFIDTSVDNAVDRQWQWFLCNEPFFWWQDGAPEGVPTIVPRTINAEYWQRQCSLYFPEVNGYTYGSAKGKTAASVNSWTGGWSDSKNTSRLLWVNGQYDPWRDSGVSSTHRPGGPLASTADEPVQIIPGGFHCSDLYIKDYYANAGVKQVVDNAVAQIKSWVAEYYK

SEQ ID NO: 8 - protein, 525 aa, Aspergillus homomorphus
MRFCSPVSVVAVTALWASLTAALRPPRLAPRPVTATTQSAVVESTFEQLIDHNDPSKGTFSQRYWYSTQYWGGPGSPVVLFTPGEAAADGYGGYLTNRTLTGVYAQQLQGAVVLIEHRYWGGSSPYANLTAETLQYLTLEQSVLDLTYFAENVQLGFAKNSTSSNAPHVPWVLVGGSYSGALTAWTEHLAPGTFWAYHATSAPMESIYDFWTYFRPIQEGMAKNCSKDVSLVAEHVDKVGKLGTKAQQKALKKLFGLEALEHFDDFAAVLPIGPYLWQDNSFATGYSGFFAFCDAVENVEAGAAVTPGAEGVGLEKALKGYANWFKNKILPDYCASTYGYWSDKYTVACFDTYNATSPLFRDTSVRNAVDRQWTWFLCNEPFFWWQDGAPESETSLIPRLVSADYWQRQCSLYFPEVNGYTYGSAKGKTASTFNAWTDGWFLTGNSTRLIWTNGQYDPWRDAGVSSIFRPGGPLVSTPNEPVQIIPGGFHCSDLYISDAEVNAGVKKVVINEVAQIKAWVAEFYA

SEQ ID NO: 9 - protein, 741 aa, Rasamsonia emersonii
MRAVQLLPSLAGLIGAASAVGCPYLTGQLDGREVHNPHEFQRRQDSGDAAASTEQFLSQFYLNDNNSYMTTDVGGPISDQNSLRAGERGPTLLEDFIFRQKIQHFDHERVPERAVHARGAGAHGTFTSYGNWSNITAASFLSAEGKETPVFVRFSTVAGSRGSSDTARDVHGFATRFYTDEGNFDIVGNNIPVFFIQDAILFPDLIHAVKPSPENEIPQAATAHDSAWDFFSQQPSALHTVFWAMSGHGIPRSFRHMDGFGVHTFRFVTDDGSSKLVKFHWTSLQGRAGLVWEEAQAAAGKNLDYMRQDLYDNIEAGRYPEWELGVQIVDEEDQLKFGFDLLDPTKILPVEYVPITPLGKLQLNRNPLNYFAETEQIMFQPGHIVRGIDFTEDPLLQGRLFSYLDTQLNRNGGPNFEQLPINRPRVPFHNNNRDGASQAFIPLNKAAYSPNTLNNGNPKQANQTVGDGFFTTPGRTASGRLLRAVSSTFSDVWSQPRLFYNSLVPAEQQFLINAIRFENSNVKSEVVRKNVITQLNRVDNDLARRVARAIGVEEPEPDPTYYHNNKTANVGTFGTPLKRIDGLKVGVLATVGDPDSISQGQSLSDTLSDSNVVVTVVAESFTDGVDALYTNSDATNFDAVIVADGAEGLFAPSSFTAQPTNSSSTASLYPAGRPLQILVDAFRFGKPVGALGSGSKALDAAGISKSRPGVYVANSISEAFTDAIEDGLRTFKFLDRFALDE

SEQ ID NO: 10 - protein, 732 aa, Penicillium antarcticum
MHALALFTGLVGVANAACPYMTGDIADSPHSIERRNDGDAAATEEFLSQFYLNDEDTYLTSDVGGPIEDQNSLKAGERGPTLLEDFIFRQKIQRFDHERVPERAVHARGTGAHGTFTSYGDWSNLTAASFLSAKGKQTPMFTRFSTVAGSRGSADTARDVHGFATRFYTEEGNFDIVGNNIPVFFIQDAILFPDLIHAVKPRGDNEIPQAATAHDSAWDFFSQQPSALHTLLWAMAGHGIPRSFRHVDGFGVHTFRMVTDKGASKLVKFHWKGMQGKASFVWEEAQQAAGKNADFMRQDLFEAIEAGRFPEWELGVQIMDEEDQLRFGFDLFDPTKIVPEELVPVTKLGKMQLNRNPMNYFAETEQAMFQPGHIVRGIDFTEDPLLQGRIFSYLDTQLNRHGGPNFEQLPINRPRVPIHNNNRDGAGQMFIPLNKYAYTPNTPNSGSPKQANQTVGNGFFTSPDRTTTGHLTRSKSSTFEDVWSQPRLFWNSLVPAEKQFVVDAMRFENSNVKSEVVRNNVIIQLNRISNDLAKRVASAIGVDAPEPDSTFYHDNTTAHIGAFGQKLTKLDGLKVGLLASVANASSIQQGAKLQSALKSAGVDVVVVAERMADNVNQTYSASDAVQFDAVVIADGAEGLFSSRSFTGSPKNKGSGATSLYPAGRPLDILLDAFRFGKPVAAVGGGSAALRAGLISAEREGVYVGKSVGEEFVKDVKEGLKTFKFLDRFALDE

SEQ ID NO: 11 - protein, 730 aa, Penicillium oxalicum
MRAVGLVTGLIGIANAACPYMTGETAGLDRRGEKDAASGTEEFLSEFYLKDDENVFLTSDVGGPIEDQNSLKAGERGPTLLEDFIFRQKIQRFDHERVPERAVHARGAGAHGVFTSYGDWSNITAASFLSAKGKETPMFVRFSTVAGSRGSADTARDVHGFATRFYTDEGNFDIVGNNIPVFFIQDAIKFPDLIHAVKPRGDNEIPQAATAHDSAWDFFSQQPSSLHTLLWAMAGHGIPRSFRHVDGFGVHTYRLVTDKGDTKLVKFHWKGLQGKASLVWEEAQQVSGKNGDFMRQDLFDAIEAGRYPEWELGVQIMEEDDQLRFGFDLLDPTKIVPEELVPVVKLGKMTLNRNPMNYFAETEQVMFQPGHIVRGVDFTDDPLLQGRIYSYLDTQLNRHGGPNFEQIPINRPRVPIHNNNRDGAGQMYIPLNPNAYSPNTLNKGSPKQANETVGKGFFTAPGRTSSGKLLRAVSSTFEDVWSQPRLFWNSLVPAEQQFVVDAMRFENANVMSQVVRNNVVIQLNRISNDLAKRVAEAIGVDAPQPDPTYYHDNTTANIGAFGQKLKKLEGLKVGVLASVANASSISQGAALQSQLKDVGVDVVVVGERMAHGVNQTYSASDAINFDAVIVADGAEGLFSTSSSTVSPKAKSSGATSLYPAGRPMDILLDAFRFGKPVGSLGQGSVALENAQISSDRDGVYAAKSVDKDFGDKVKEGLRTFKFLDRFALDE

SEQ ID NO: 12 - protein, 727 aa, Aspergillus awamori
MRPIGLVGLIGLANAACPYMSRDLSPRDSSDASESTEEFLSQYYLNDNNTYLTSDVGGPIEDQNSLSAGERGPTLLEDFIFRQKIQRFDHERVPERAVHARGVGAHGVFVSYGDFSNLTAASFLSEQGKETPMFVRFSTVAGSRGSTDLARDVHGFATRFYTDEGNFDLVGNNIPVFFIQDAIQFPDLIHAVKPRGDSEIPQAATAHDSAWDFFSQQPSALHTLFWAMAGHGIPRSFRHVDGFGVHTYRLVTDSGASKLVKFHWKSLQGKASMVWEEAQQVSGKNSDFMRQDLWTSIEYGRYPEWELGVQIMDEEDQLRFGFDLFDPTKIVPEEYVPITKLGKMTLNRNPLNYFAETEQVMFQPGHIVRGVDFTEDPLLQGRLFSYLDTQLNRHGGPNFEQLPINQPRVPIHNNNRDGAGQMFIPLNPNAYSPNTLNSASPKQANQTTGNGFFTSPGRTTSGHLLRSTSPTFQDVWSQPRLFYNSLVPTEQQFLIDAIRFETSNVKSTTVRQNVIIQLNRISNDLARRVARAIDVPAPDPDPTYYHDNKTADVGTFGTKLKKLSNLRVGFLASVQTPSSITAAQDLATELKDDEVDVVVVAERLTDGVDQTYSASDAIQFDAVIVAPGAEGLFASGSVTAPQLNSTASAVSTLYPAGRPLQVLVDAFRFGKTVGAVGSGEGALRNAGIDDEREGVVVGQTIGADFVDSVREGLRTFRFLDRFALDEE

SEQ ID NO: 13 - protein, 527 aa, Aspergillus bertholletius
MHFLAPLSVVTLLASWPLLGYAIHPPKPVPPPVSRPVSTRSSAVVGEATFDQLLDHHDSSKGTFSQRYWWSTEYWGGPGSPVVLFTPGEASADGYQGYLTNTTLTGRYAQEIQGAVILIEHRYWGGSSPYKELTAETLQYLTLEQSILDLTYFAETVSLEFDPSNRSNAPKAPWVLVGGSYSGALAAWTAAVAPETFWAYHATSAPVEAINDFWQYFDPIRQGMAPNCSRDVSLVATHIDRVGKHGSAAEQLALKELFGLGAVEHYDDFAAALPIGPYKWQSNTFVTGYSGFFAFCDAVENVKAGATVVPGPEGVGLQKALRGYAKWFKSTILPGYCANYGYWTDNQTVACFDTYNPSSAIFTDTSVDNAVDRQWQWFLCNEPFFWWQDGAPEGIPTIIPRTVNAAYWQRQCSLYFPEVNGYTYGSAKGKTAATVNQWTGGWSATRNTSHLLWVNGQYDPWRDSGVSSIYRPGGPLKSTADEPVQVIPGGFHCSDLYLKDYYANDGVKQVIDNAVAQIKSWVAEYYN

(19) United States
(12) Patent Application Publication
(10) Pub. No.: US 2025/0304890 A1
(43) Pub. Date: Oct. 2, 2025

(54) METHOD FOR PRODUCING BEER

(71) Applicant: INTERNATIONAL N&H DENMARK APS, Kongens Lyngby (DK)

(72) Inventor: Jacob Flyvholm Cramer, Højbjerg (DK)

(21) Appl. No.: 18/720,068

(22) PCT Filed: Dec. 20, 2022
(86) PCT No.: PCT/EP2022/087117

§ 371 Date: Jun. 14, 2024

(30) Foreign Application Priority Data
Dec. 21, 2021 (EP) 21216613.6

(51) Int. Cl. C12C 5/00

(52) U.S. Cl. CPC C12C 5/004; C12Y 101/03004; C12Y 111/01006

(57) ABSTRACT

The present invention relates to a method for producing beer and beer-related beverages, wherein said method comprises adding catalase enzyme after mash boiling and/or during or after wort preparation and/or the fermentation phase and/or maturation and/or stabilization and/or pasteurization phases of the brewing process to improve the flavour and/or flavour stability of the finished beer. The catalase may additionally or alternatively be added to the finished beer itself.

### CROSS-REFERENCE TO RELATED APPLICATIONS

This application is a U.S. National Stage Application under 35 U.S.C. § 371 of International Application No. PCT/EP2022/087117, filed Dec. 20, 2022, which claims priority to EP Application No. 21216613.6, filed Dec. 21, 2021, all of which are hereby incorporated by reference in their entireties.

### INCORPORATION BY REFERENCE OF THE SEQUENCE LISTING

The present application is being filed with a Sequence Listing in electronic format. The Sequence Listing is provided as a file entitled NB42056_SequenceListing.xml, created on Jun. 6, 2024, which is 20,992 bytes in size. The information in the electronic format of the Sequence Listing is incorporated by reference in its entirety.

### FIELD OF THE INVENTION

The present invention relates to a method for producing beer and beer-related beverages, wherein said method comprises adding a catalase enzyme after mash boiling and/or during or after the wort preparation and/or fermentation phase and/or maturation and/or stabilization and/or pasteurization phases of the brewing process to improve the flavour and/or flavour stability of the finished beer. The catalase may additionally or alternatively be added to the finished beer itself.

### BACKGROUND TO THE INVENTION

The process of producing beer comprises several stages. In general, the brewing process may involve heating the crushed malt and other grains with water during mashing to form wort.

Yeast is then added to the wort in order to ferment any fermentable sugars present in the wort to alcohol. The beer may then be further matured and/or stabilized prior to bottling, in order to achieve the desired flavour and flavour stability. The maturation and stabilization phases may be referred to as the “lagering” period.

One issue that may be faced in brewing is the potential detrimental effect of oxidation on the flavour and stability of the beer produced. Preferably, the flavour of the finished beer should have a stability commensurate with the desired shelf-life of the finished product. There is therefore a need in the art to provide an improved brewing process facilitating increased oxidative stability (and therefore reduced free radical production), and hence improved flavour and flavour stability throughout the shelf-life of the finished product.

Enzymes are often added during brewing that contribute to beer quality in terms of colour, clarification, flavour, or texture. The variety enzyme applications covers a large range. Catalase is an antioxidant enzyme that catalyzes the reaction of the decomposition of hydrogen peroxide into water and oxygen. Moreover, catalase can act as peroxidase at low hydrogen peroxide levels.

### SUMMARY OF THE INVENTION

The present inventors have surprisingly found an advantageous effect on beer flavour and flavour stability of adding a catalase enzyme during or after the brewing process. The present invention is therefore directed to adding catalase after mash boiling and/or during or after wort preparation and/or fermentation and/or maturation and/or stabilization and/or pasteurization of the beer, or to the final beer itself. Advantageously, the positive effect on flavour through the reduction of Strecker aldehydes and/or flavour stability is achieved in the final beer throughout its shelf-life.

The advantageous effect of the catalase may be related to oxidative effects. Oxidation may have detrimental effects on the flavour and flavour stability of beer. Without wishing to be bound by theory, it is thought that the catalase can only act on the prooxidative radical generation if hydrogen peroxide is formed, for example, after the consumption of the endogenous antioxidative potential (EAP). Frederiksen et al. suggested that applying catalase during mashing to beer could lead to a reduction in radical formation rate (Frederiksen et al. Journal of Agricultural and Food Chemistry, 56 (2008), 18, pp. 8514-8520).

To determine the lag-time or endogenous anti-oxidative potential (EAP value) of a beer as a shelf life indicator, analysis can be carried out by electron spin resonance spectroscopy (ESR).

ESR gives forced aging via increased temperatures, which results in aging processes in the beer being tested. Concerning ESR-measurement, the value of the lag-time or EAP value determines the endogenous anti-oxidative beer stability, which correlates with the flavour stability of the beer.

The present invention provides a method for producing a beer with improved flavour and/or flavour stability, wherein said method comprises adding a catalase composition after mash boiling and/or during or after wort preparation and/or fermentation and/or maturation and/or stabilization and/or pasteurization, and/or comprises adding a catalase composition to the final beer.

Adding enzyme compositions during beer production for improved beer brewing is common practice in the industry. It is also well known that exogenous enzymes can be added, specifically at the mashing step.

However, when catalase is added at the mashing step, the heat impact from the process leads to a denaturation of the enzyme and furthermore an increase of iron ions. Iron ions accelerate oxygen activation, resulting in a higher aging susceptibility.

Advantageously, the catalase may be active after mash boiling and/or during or after wort preparation and/or fermentation and/or maturation and/or stabilization and/or pasteurization of the beer. The catalase may be added after boiling of the mash in order to avoid inactivation of the catalase early in the brewing process. In one aspect of the invention, catalase may be added after wort boiling. In one aspect the may additionally be added prior to wort boiling.

In one aspect of the invention catalase may be added at more than one stage of the brewing process. For example, catalase should be added after mash boiling and/or during or after wort preparation and/or fermentation and/or maturation and/or stabilization and/or pasteurization, but may also be added e.g. during mashing and/or before fermentation. The catalase may also be added directly to the final beer.

In one aspect the catalase is a microbial catalase. In a preferred aspect said microbial catalase is derivable from a bacterium or a fungus. In one aspect the microbial catalase is derived from Aspergillus, Bacillus, Saccharomyces, Escherichia, Pseudomonas, Trichoderma, or Scytalidium sp. In one aspect the microbial catalase is derived from Aspergillus niger, Aspergillus oryzae, Bacillus subtilis, Bacillus licheniformis, Bacillus fragilis, Bacillus pumilus, Bacillus halodurans, Saccharomyces cerevisiae, Escherichia coli, Pseudomonas aeruginosa, Trichoderma reesei, or Scytalidium thermophilum. In a preferred aspect the microbial catalase is derivable from an Aspergillus sp. or Trichoderma sp., preferably A. niger or T. reesei. More preferably, the catalase is derivable from A. niger.

In a preferred aspect said catalase has or comprises a sequence according to any of SEQ ID NOs: 1, 2, 3 or 4, or a sequence with at least 70% identity thereto. For example, said catalase may have a sequence with at least 75%, 80%, 85%, 90%, 95%, 96%, 97%, 98%, 99% or 100% identity to any of SEQ ID NOs:1, 2, 3, or 4. In one aspect the catalase may comprise or consist of a sequence according to SEQ ID NO: 1, 2, 3, or 4, or a sequence having at least 70% identity thereto. Most preferably the catalase according to the invention has the sequence of SEQ ID NO: 1. The catalase may be produced by recombinant techniques which will be well known to persons skilled in the art.

In one aspect of the present invention, the catalase composition further comprises glucose oxidase.

The invention also encompasses a beer obtained or obtainable by a method according to the invention. In one aspect the final beer comprises catalase as described herein. The final beer may also or alternatively comprise glucose oxidase.

In one aspect of the invention, the oxidative stability of the beer is improved.

In one aspect of the invention the generation of Strecker aldehydes in the beer is reduced, including a reduction in the generation of benzaldehyde and/or trans-2-Nonenal.

The invention also encompasses use of a catalase composition, as described herein in the production of beer, wherein said catalase composition is added after mash boiling and/or during or after wort preparation and/or fermentation and/or maturation and/or stabilization and/or pasteurization, and/or is added to the final beer.

In one aspect, the catalase composition has a catalase activity of at least 0.1 U/ml.

In one aspect, the catalase composition has a catalase activity of at least 1 U/ml.

In one aspect, the catalase composition has a catalase activity of at least 10 U/ml.

In one aspect, the catalase composition has a catalase activity of at least 100 U/ml.

In one aspect, the catalase composition has a catalase activity of at least 1,000 U/ml.

In one aspect, the catalase composition has a catalase activity of at least 10,000 U/ml.

In one aspect, the catalase composition has a catalase activity of at least 100,000 U/ml.

In one aspect, the catalase composition provides a catalase activity of at least 0.1 U/ml to the mash boiled preparation and/or the wort preparation and/or the fermented preparation and/or the maturation preparation and/or the stabilized preparation and/or the pasteurized preparation and/or the final beer.

In one aspect, the catalase composition provides a catalase activity of at least 1 U/ml to the mash boiled preparation and/or the wort preparation and/or the fermented preparation and/or the maturation preparation and/or the stabilized preparation and/or the pasteurized preparation and/or the final beer.

In one aspect, the catalase composition provides a catalase activity of at least 10 U/ml to the mash boiled preparation and/or the wort preparation and/or the fermented preparation and/or the maturation preparation and/or the stabilized preparation and/or the pasteurized preparation and/or the final beer.

In one aspect, the catalase composition provides a catalase activity of at least 100 U/ml to the mash boiled preparation and/or the wort preparation and/or the fermented preparation and/or the maturation preparation and/or the stabilized preparation and/or the pasteurized preparation and/or the final beer.

In one aspect, the catalase composition provides a catalase activity of at least 1,000 U/ml to the mash boiled preparation and/or the wort preparation and/or the fermented preparation and/or the maturation preparation and/or the stabilized preparation and/or the pasteurized preparation and/or the final beer.

In one aspect, the catalase composition provides a catalase activity of at least 10,000 U/ml to the mash boiled preparation and/or the wort preparation and/or the fermented preparation and/or the maturation preparation and/or the stabilized preparation and/or the pasteurized preparation and/or the final beer.

In one aspect, the catalase composition provides a catalase activity of at least 100,000 U/ml to the mash boiled preparation and/or the wort preparation and/or the fermented preparation and/or the maturation preparation and/or the stabilized preparation and/or the pasteurized preparation and/or the final beer.

In one aspect, there is a reduction in the generation of Strecker aldehydes in the mash boiled preparation and/or the wort preparation and/or the fermented preparation and/or the maturation preparation and/or the stabilized preparation and/or the pasteurized preparation and/or the final beer.

In one aspect, the generation of Strecker aldehydes in the final beer is reduced.

In one aspect, there is a reduction of trans-2-Nonenal generation in the mash boiled preparation and/or the wort preparation and/or the fermented preparation and/or the maturation preparation and/or the stabilized preparation and/or the pasteurized preparation and/or the final beer.

In one aspect, there is a reduction of trans-2-Nonenal generation in the final beer.

In one aspect, there is at least 10% at least, 20% at least 30%, at least 40%, or at least 50% in trans-2-Nonenal generation, preferably a reduction of at least 50% in trans-2-Nonenal generation.

In one aspect, there is a reduction of trans-benzaldehyde generation in the mash boiled preparation and/or the wort preparation and/or the fermented preparation and/or the maturation preparation and/or the stabilized preparation and/or the pasteurized preparation and/or the final beer.

In one aspect, there is a reduction of trans-benzaldehyde generation in the final beer.

In one aspect, there is a reduction of at least 10%, at least 20%, at least 30%, at least 40%, or at least 50% in Benzaldehyde generation, preferably a reduction of at least 50% Benzaldehyde generation.

In one aspect, the shelf-life of the beer is extended.

In one aspect, the shelf-life of the beer is extended to at least about 4 months, or to at least about 6 months, or to at least about 9 months, or to at least about 12 months, or to at least about 24 months.

The present invention also provides the use of a catalase composition in the production of beer, wherein said catalase composition is added after mash boiling and/or during or after wort preparation and/or fermentation and/or maturation and/or stabilization and/or pasteurization, and/or is added to the final beer.

In one aspect, in the use according to the present invention, the catalase composition is the catalase composition according to the present invention.

The present invention also provides a beer obtained or obtainable by a method according to the present invention.

The present invention also provides a beer comprising catalase.

The present invention also provides a beer comprising catalase and glucose oxidase.

In one aspect, the shelf-life of the beer is extended to at least about 4 months.

In one aspect, the shelf-life of the beer is extended to at least about 6 months.

In one aspect, the shelf-life of the beer is extended to at least about 9 months.

In one aspect, the shelf-life of the beer is extended to at least about 12 months.

In one aspect, the shelf-life of the beer is extended to at least about 24 months.

In one aspect, the shelf-life of the beer is extended by at least about 4 months.

In one aspect, the shelf-life of the beer is extended by at least about 6 months.

In one aspect, the shelf-life of the beer is extended by at least about 9 months.

In one aspect, the shelf-life of the beer is extended by at least about 12 months.

In one aspect, the shelf-life of the beer is extended by at least about 24 months.

In one aspect, the flavour stability of the beer is improved.

### BRIEF DESCRIPTION OF THE FIGURES

FIG. 1 depicts the results of the EAP and T600 determination by means of POBN in oxidative wort stability by addition of catalase as set forth SEQ ID NO: 1 by forcing test 60° C. and 3.5 mM POBN using 0.0, 4.4, 8.8, 22.1 and 44.2 U/ml as shown in legends.

FIG. 2 depicts the results of the EAP and T600 determination by means of POBN in oxidative wort stability by addition of catalase as set forth SEQ ID NO: 1 by forcing test 60° C. and 3.5 mM POBN using 0.0, 0.9, 1.8, 2.7, 3.5, 4.4 and 6.2 U/ml as shown in legends.

FIG. 3 depicts the results of the EAP and T600 determination by means of POBN in oxidative low EAP beer (pilsner type) stability by addition of catalase as set forth SEQ ID NO: 1 by forcing test 60° C. and 3.5 mM POBN using 0.0, 0.2, 0.4, 0.8, 1.6, 2.4, 3.1 and 3.9 U/ml as shown in legends.

FIG. 4 depicts the results of the EAP and T600 determination by means of POBN in oxidative medium EAP beer (pilsner type) stability by addition of catalase as set forth SEQ ID NO: 1 by forcing test 60° C. and 3.5 mM POBN using 0.0, 0.2, 0.39, 0.79 and 1.97 U/ml as shown in legends.

FIG. 5 depicts the standard MEBAK beer analytics of Tuborg and Odense pilsner (Denmark) used for storage stability trials.

FIG. 6 depicts an ESR-measured storage trial using: (Odense pilsner fresh, Odense with 650 μl H₂O and one month storage, Odense with 650 μl catalase as set forth SEQ ID NO: 1 and one month storage; Tuborg fresh, Tuborg with 650 μl H₂O and one month storage, Tuborg with 650 μl catalase as set forth SEQ ID NO: 1 and one month storage).

FIG. 7 depicts the mashing program used for lab-scale malt-based mashing trials.

FIG. 8 depicts wort analysis (extract, pH and colour) of dark beer wort with and without catalase as set forth SEQ ID NO: 1.

FIG. 9 depicts an ESR-measured mashing trial of dark beer wort with and without catalase as set forth SEQ ID NO: 1 addition during mashing preparation (dark beer wort with 0.63 U/ml catalase (A. niger), dark beer wort with 1.26 U/ml catalase (A. niger), dark beer wort with 0.63 U/mL catalase (T. reesei), dark beer wort with 1.26 U/ml catalase (T. reesei), dark beer wort after boiling with 0.63 U/mL catalase (A. niger), dark beer wort after boiling with 0.63 U/ml catalase (T. reesei), and a control/reference dark beer wort).

FIG. 10 depicts GCMS-SPME relative quantification of the following Strecker aldehyde off-flavours in accelerated beer oxidation trials: 2-Methylfuran, Hexanal, 2-Butenal, trans-3-Penten-2-one, 4-Hexen-3-one, Furfural, trans-2-Nonenal, Benzaldehyde, Phenylacetaldehyde and Ethylnicotinate, as well as two unidentified substances (ion, RT: 10.21; Ion: 95.00/not identified and RT: 9.25; Ion: 81.00/not identified). Control beer was un-opened and kept retained at room temperature (RT) for 14 days. Headspace oxidation beer samples were incubated at either 30° C. or 60° C. for up to 14 days to accelerate oxidation as indicated by the labels.

FIG. 11a depicts beer freshness in terms of free radical generation measured in uM for beer freshness trials with the following additives: Foodpro CAT A. niger catalase, FL002_GC119 T. reesei catalase, Sodium Metabisulfite (Na₂S₂O₅), and FL003 Guardian Acerola acerola juice concentrate. These were added to bottles wither stored in a coldroom for 14 days, or at 30° C. for 14 days with a headspace air flush.

FIGS. 11b, 11c and 11d depict the same data as FIG. 11a, but with samples with similar free radical generation grouped together. FIG. 11b depicts samples O1FA22 and O1FA22_no, with no freshness protection and poor oxidation rate. FIG. 11c depicts samples with acceptable freshness performance, but poor oxidation. FIG. 11d samples with low to acceptable freshness protection but better oxidation performance.

FIG. 11e depicts oxidation rate of the beer samples, ranked from lowest to highest, with lower oxidation rates favoured for beer.

### DETAILED DESCRIPTION OF THE INVENTION

The process of beer-brewing is well known to the person skilled in the art. A standard process may comprise providing malted barley and/or unmalted adjuncts, referred to as the grist. The next stage in the process may comprise mashing the grist with water (with heating and stirring), in order that the carbohydrates are degraded to fermentable sugars by the aid of the enzymes naturally present in the malt. The impact of enzymes in the brewing process plays an important role. Usually, the malt contains many enzymes, which are most active when the kernel comes into contact with the lautering water (where lautering is the process of separating wort from the solids). This may be referring to as the mashing phase. Temperatures during the later stage of the mashing process may reach over 75° C.

Following mashing, the liquid extract, referred to as the wort, is separated from the solids (spent grain particles and adjuncts) in order to get clear wort. Hops may then be added to the wort. After addition of hops, the wort is then boiled and cooled to facilitate addition of yeast. The fermentation stage involves fermentation of fermentable sugars to alcohol by the yeast. After a main fermentation, lasting typically 5-10 days, most of the yeast is removed and the so-called “green beer” is formed.

The “green” beer resulting from this primary fermentation still contains some non-settled yeasts as well as relatively high levels of undesirable flavour components, such as diketones, such as diacetyl and acetyl aldehyde. During the maturation phase these undesirable flavour components are converted into bland tasting compounds. For example, during maturation the amount of diacetyl, a compound with a buttery off-flavour, may be converted into tasteless acetoin. In the subsequent stabilization phase, colloidal stability of the beer may be increased. In this regard, the beer may be retained to promote formation of protein polyphenol aggregates, followed by removal of precipitated aggregates, for example by filtration/precipitation.

The phase which incorporates both the maturation and stabilization phases of beer production may be referred to as the lagering period.

According to the invention an enzyme composition comprising a catalase is added during the brewing process at a time point later than the mashing step and/or later than wort boiling. Catalase may be added after mash boiling and/or during or after wort preparation and/or fermentation and/or maturation and/or stabilization and/or pasteurization, and/or is added to the final beer.

The beer produced by the process according to the invention may be any type of beer. The term “beer” as used herein is intended to cover at least beer prepared from mashes prepared from unmalted cereals as well as all mashes prepared from malted cereals, and all mashes prepared from a mixture of malted and unmalted cereals. The term “beer” covers bottom fermented but also top fermented beers as well as beers prepared with adjuncts, and beers with all possible alcohol contents.

Preferred beer types comprise ales, strong ales, stouts, porters, dark beers, pilsners, lagers, bitters, export beers, malt liquors, happoushu, high-alcohol beer, low-alcohol beer, low-calorie beer or light beer. The invention also extends to non- or low-alcohol beers. In a preferred aspect the beer may be an IPA, pilsner or low- or no-alcohol beer.

In one aspect of the invention the shelf-life of the beer may be improved or extended. In one aspect the shelf-life may be extended to 4, 6, 9, 12, or 24 months.

In one aspect of the invention, the generation of Strecker aldehydes may be reduced, including a reduction in the generation of trans-2-Nonenal and/or benzaldehyde by at least 10%, at least 20%, at least 30%, at least 40%, or at least 50%. Preferably, the generation of trans-2-Nonenal and/or benzaldehyde is reduced by at least 50%.

Advantageously, the present invention may facilitate a reduction in the amount of sulfites used in the brewing process, or present in the final beer product.

The beer obtained according to the present invention will typically be packaged. Any suitable packaging may be used, for example a bottle, a keg or a can. Beer prepared according to the invention may also be packaged in a bulk-tank. Accordingly, the invention provides a packaging comprising the beer obtained according to the invention, for example a bottle, a keg or a can comprising such a beer.

### General Definitions

Unless defined otherwise, all technical and scientific terms used herein have the same meaning as commonly understood by one of ordinary skill in the art to which this disclosure belongs. This disclosure is not limited by the exemplary methods and materials disclosed herein, and any methods and materials similar or equivalent to those described herein can be used in the practice or testing of embodiments of this disclosure. Numeric ranges are inclusive of the numbers defining the range.

The headings provided herein are not limitations of the various aspects or embodiments of this disclosure which can be had by reference to the specification as a whole. Accordingly, the terms defined immediately below are more fully defined by reference to the specification as a whole. As used herein, the term “polynucleotide” it is synonymous with the term “nucleotide sequence” and/or the term “nucleic acid sequence”. Unless otherwise indicated, any nucleic acid sequences are written left to right in 5′ to 3′ orientation.

The term “protein”, as used herein, includes proteins, polypeptides, and peptides. As used herein, the term “amino acid sequence” is synonymous with the term “polypeptide” and/or the term “protein”. In the present disclosure and claims, the name of the amino acid, the conventional one-letter and three-letter codes for amino acid residues may be used. The 3-letter code for amino acids as defined in conformity with the IUPACIUB Joint Commission on Biochemical Nomenclature (JCBN). It is also understood that a polypeptide may be coded for by more than one nucleotide sequence due to the degeneracy of the genetic code. Unless otherwise indicated, any amino acid sequences are written left to right in amino to carboxy orientation.

Other definitions of terms may appear throughout the specification. Before the exemplary embodiments are described in more detail, it is to understand that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within this disclosure. The upper and lower limits of these smaller ranges may independently be included or excluded in the range, and each range where either, neither or both limits are included in the smaller ranges is also encompassed within this disclosure, subject to any specifically excluded limit in the stated range. Where the stated range includes one or both of the limits, ranges excluding either or both of those included limits are also included in this disclosure.

It is to be noted that as used herein and in the appended claims, the singular forms “a”, “an”, and “the” include plural referents unless the context clearly dictates otherwise.

The terms “comprising”, “comprises”, “has”, “having” and “comprised of” as used herein are synonymous with “including”, “includes” or “containing”, “contains”, and are inclusive or open-ended and do not exclude additional, non-recited members, elements or method steps. The terms “comprising”, “comprises”, “has”, “having” and “comprised of” also include the term “consisting of’.

The publications discussed herein are provided solely for their disclosure prior to the filing date of the present application. Nothing herein is to be construed as an admission that such publications constitute prior art to the claims appended hereto.

As used herein, the term “pasteurization” means the killing of micro-organisms in aqueous solution by heating. Implementation of pasteurization in the brewing process is typically through the use of a flash pasteurizer or tunnel pasteurizer. As used herein, the term “pasteurization units or PU” refers to a quantitative measure of pasteurization. One pasteurization unit (1 PU) for beer is defined as a heat retention of one minute at 60 degrees Celsius. One calculates that:

PU=t×1.393\hat{ }(T), where:
t=time, in minutes, at the pasteurization temperature in the pasteurizer
T=temperature, in degrees Celsius, in the pasteurizer—here 60° C.
[\hat{ }(T) represents the exponent of (T)]

Different minimum PU may be used depending on beer type, raw materials and microbial contamination, brewer and perceived effect on beer flavour. Typically, for beer pasteurization, 14 to 15 PU are required. Depending on the pasteurizing equipment, pasteurization temperatures are typically in the range of 60 to 72 degrees Celsius with a pasteurization time calculated accordingly. Further information may be found in “Technology Brewing and Malting” by Wolfgang Kunze of the Research and Teaching Institute of Brewing, Berlin (VLB), 3rd completely updated edition, 2004, ISBN 3-921690-49-8.

### Catalase

Catalase enzymes catalyze the first order reaction:

2H₂O₂→2H₂O+O₂

A catalase for use according to the present invention may belong to EC 1.11.1.6.

In a preferred embodiment the catalase is a microbial catalase, such as a catalase isolated or derivable from a fungus or bacterium. In one aspect the microbial catalase is derived from Aspergillus, Bacillus, Saccharomyces, Escherichia, Pseudomonas, Trichoderma, or Scytalidium sp. In one aspect the microbial catalase is derived from Aspergillus niger, Aspergillus oryzae, Bacillus subtilis, Bacillus licheniformis, Bacillus fragilis, Bacillus pumilus, Bacillus halodurans, Saccharomyces cerevisiae, Escherichia coli, Pseudomonas aeruginosa, Trichoderma reesei, or Scytalidium thermophilum.

In a preferred aspect the catalase is derived from Aspergillus or Trichoderma, preferably Aspergillus niger or Trichoderma reesei. More preferably, the catalase is derived from Aspergillus niger. The catalase may be produced by recombinant techniques, and such methods are well known in the art. In one aspect the catalase may be expressed in Aspergillus niger or Trichoderma reesei.

A catalase suitable for use according to the present invention may be recovered from recombinant cell cultures by methods well-known to those skilled in the art, including for example ammonium sulfate or ethanol precipitation, acid extraction and chromatographic methods such as high performance liquid chromatography (HPLC).

A catalase suitable for use according to the invention may be a naturally-purified product, a product or a chemical synthesis, a product produced by a recombinant technique from a prokaryotic or eukaryotic host, including, for example. Bacterial, yeast, fungal, higher plant, insect and mammalian cells.

The catalase may be mixed with carriers or diluents which will not interfere with the intended purpose of the catalase. In one aspect, the catalase suitable for use according to the invention may be in a substantially purified form. In one aspect, the catalase may not be purified. As discussed further below, the invention advantageously allows for the presence of glucose oxidase side-activity in the catalase composition, i.e. there is increased tolerance for the presence of glucose oxidase. This is economically beneficial as it means that glucose oxidase does not need to be purified out of the catalase composition, which can save the cost of further purification.

Catalase activity may be measured in Baker Units/g, wherein 1 Baker Unit is defined as that amount of catalase which will decompose 264 mg hydrogen peroxide at a “double exhaustion” analysis based on the simultaneous inactivation of catalase by hydrogen peroxide and the breakdown of hydrogen peroxide by catalase after 60 minutes incubation at pH 7.0 and 25.0° C. In one aspect of the invention, catalase is added at a dose of at least about 7000 U/l wort. In one aspect, catalase is added at a dose of at least about 5000 U/l wort. In one aspect, catalase is added at a dose of at least about 2000 U/l wort. In one aspect, catalase is added at a dose of at least about 1000 U/l wort. In one aspect, catalase is added at a dose of at least about 500 U/l wort. Preferably, catalase is added at a dose of at least about 7000 U/l wort.

Catalase activity may alternatively be measured in CIU. The degradation of hydrogen peroxide may be monitored using spectrophotometry at 240 nm. The time taken for a specified decrease in absorbance at a specified H₂O₂ concentration is an expression of catalase activity. One CIU is defined as the enzyme activity that will degrade 1 μM H₂O₂ per minute at pH 7.0 and 25° C., reducing the H₂O₂ concentration from 10.3 mM to 9.2 mM.

### Reaction Conditions:

Enzyme concentration approx. 100 CIU/ml
Substrate concentration 10.3 mM H₂O₂
Buffer 50 mM phosphate
Temperature 25° C.
pH 7.0

### Detection:

Wavelength 240 nm
Absorbance range 0.450 to 0.400
Time range 0.267 to 0.400 minutes (16 to 24 seconds)

In a preferred aspect the catalase comprises a sequence of SEQ ID NO: 1 or SEQ ID NO: 2, or a sequence having at least 70% identity thereto. In a preferred aspect the catalase comprises a variant, fragment, derivative or homologue of the sequence of SEQ ID NO: 1 or SEQ ID NO: 2 as defined herein below. The variant, fragment, derivative or homologue according to the invention has catalase activity. The catalase may be in isolated form.

### Sequence Identity

In addition to the specific amino acid sequences and polynucleotides mentioned herein, the present invention encompasses variants, homologues, derivatives and fragments thereof. The term “variant” is used to mean a nucleotide sequence or amino acid sequence which differs from a wild-type sequence.

For example, a variant may include substitutions, insertions, deletions, truncations, transversions and/or inversions at one or more position(s) relative to a wild-type sequence. Variants can be made using methods known in the art for example site scanning mutagenesis, insertional mutagenesis, random mutagenesis, site-directed mutagenesis and directed-evolution as well as using recombinant methods well known in the art. Polynucleotide sequences encoding variant amino acid sequences may readily be synthesized using methods known in the art.

In some aspects, the variant is a naturally occurring nucleotide sequence or amino acid sequence which differs from a wild-type sequence. For example, the variant may be a natural genetic variant.

The term “isolated” means that the sequence is at least substantially free from at least one other component with which the sequence is naturally associated in nature and as found in nature. In one aspect, “isolated variant” or isolated active fragment thereof as used herein refers to a polypeptide which is at least 30% pure, at least 40% pure, at least 60% pure, at least 80% pure, at least 90% pure, and at least 95% pure, as determined by SDS-PAGE.

In some aspects, the variant is an engineered variant. For example, the variant may be engineered by recombinant methods.

In one embodiment, a “wild-type sequence” is SEQ ID NO: 1.

The term “homologue” means an entity having a certain homology with the subject nucleotide sequences. Here, the term “homology” can be equated with “identity”.

In the present context, a homologous sequence is taken to include an amino acid or a nucleotide sequence which may be at least 70%, 75%, 80%, 85% or 90% identical, preferably at least 95%, 96%, 97%, 98% or 99% identical to the subject sequence. Typically, the homologues will comprise the same active sites etc. as the subject amino acid sequence for instance. Although homology can also be considered in terms of similarity (i.e. amino acid residues having similar chemical properties/functions), in the context of the present invention it is preferred to express homology in terms of sequence identity.

Suitably, a homologue of a catalase according to the present invention is an active catalase. In other words, the homologue of a variant according to the present invention has catalase activity. In one aspect, a homologous sequence is taken to include an amino acid sequence or nucleotide sequence which has one or several additions, deletions and/or substitutions compared with the subject sequence. Homology comparisons can be conducted by eye, or more usually, with the aid of readily available sequence comparison programs. These commercially available computer programs can calculate % homology between two or more sequences.

Percent homology may be calculated over contiguous sequences, i.e. one sequence is aligned with the other sequence and each amino acid in one sequence is directly compared with the corresponding amino acid in the other sequence, one residue at a time. This is called an “ungapped” alignment. Typically, such ungapped alignments are performed only over a relatively short number of residues.

Although this is a very simple and consistent method, it fails to take into consideration that, for example, in an otherwise identical pair of sequences, one insertion or deletion will cause the following amino acid residues to be put out of alignment, thus potentially resulting in a large reduction in % homology when a global alignment is performed. Consequently, most sequence comparison methods are designed to produce optimal alignments that take into consideration possible insertions and deletions without penalising unduly the overall homology score. This is achieved by inserting “gaps” in the sequence alignment to try to maximise local homology.

However, these more complex methods assign “gap penalties” to each gap that occurs in the alignment so that, for the same number of identical amino acids, a sequence alignment with as few gaps as possible—reflecting higher relatedness between the two compared sequences—will achieve a higher score than one with many gaps. “Affine gap costs” are typically used that charge a relatively high cost for the existence of a gap and a smaller penalty for each subsequent residue in the gap. This is the most commonly used gap scoring system. High gap penalties will of course produce optimised alignments with fewer gaps. Most alignment programs allow the gap penalties to be modified. However, it is preferred to use the default values when using such software for sequence comparisons.

Calculation of maximum % homology or % identity therefore first requires the production of an optimal alignment, taking into consideration gap penalties.

The relationships between protein sequences are usually discovered by aligning them together and assigning this alignment a score. There are two main types of sequence alignment. Pairwise sequence alignment only compares two sequences at a time and multiple sequence alignment compares many sequences. Two important algorithms for aligning pairs of sequences are the Needleman-Wunsch algorithm and the Smith-Waterman algorithm. Popular tools for sequence alignment include BLAST for pairwise alignment, and ClustalW, MUSCLE, or MAFFT for multiple alignment.

There are two types of pairwise alignments: local and global alignments. A local alignment is an alignment of two sub-regions of a pair of sequences. This type of alignment is appropriate when aligning two sequences that may have local regions of similarity embedded in a background of a non-homologous sequence. For local alignments, the Smith-Waterman algorithm is the most commonly used. Other pairwise alignment tools include BLAST. A global alignment is a sequence alignment over the entire length of two or more protein sequences. In a global alignment, the sequences are assumed to be homologous along their entire length. An efficient algorithm for global alignment was described by Needleman and Wunsch 1970. Multiple protein sequence alignment tools such as CLUSTALW, MAFFT and MUSCLE are applied to evaluate similarities across multiple protein sequences.

A suitable computer program for carrying out such an alignment is available in the Vector NTI (Invitrogen Corp.) software package, which uses an algorithm comparable to the CLUSTAL W iterative multiple sequence alignment algorithm (Higgins D G & Sharp P M (1988), Gene 73(1), 237-244). Examples of software that can perform sequence comparisons include, but are not limited to, the BLAST package (see Ausubel et al., 1999, Short Protocols in Molecular Biology, 4th Ed—Chapter 18), BLAST 2 (see FEMS Microbiol Lett, 1999, 174(2): 247-50; FEMS Microbiol Lett, 1999, 177(1): 187-8), FASTA (Altschul et al., 1990, J. Mol. Biol., 403-410) and AlignX for example. At least BLAST, BLAST 2 and FASTA are available for offline and online searching (see Ausubel et al., 1999, pages (7)58 to (7)60).

Although the % homology can be measured in terms of identity, the alignment process itself is typically not based on an all-or-nothing pair comparison. Instead, a scaled similarity score matrix is generally used that assigns scores to each pairwise comparison based on chemical similarity or evolutionary distance. An example of such a matrix commonly used is the BLOSUM62 matrix—the default matrix for the BLAST suite of programs. Vector NTI programs generally use either the public default values or a custom symbol comparison table if supplied (see user manual for further details). For some applications, it is preferred to use the default values for the Vector NTI package.

Once the software has produced an optimal alignment, it is possible to calculate % homology, preferably % sequence identity. The software typically does this as part of the sequence comparison and generates a numerical result.

Gap Penalties may be used when determining a sequence identity. Examples of parameters used for a pairwise alignment are as set forth in Tables 1 and 2 below.

TABLE 1
FOR BLAST

| | |
|---|---|
| GAP OPEN | 9 |
| GAP EXTENSION | 2 |

TABLE 2

| FOR CLUSTAL | DNA | PROTEIN |
|---|---|---|
| Weight Matrix | IUB | Gonnet 250 |
| GAP OPENING | 15 | 10 |
| GAP EXTEND | 6.66 | 0.1 |

In one embodiment, CLUSTAL may be used with the gap penalty and gap extension set as defined above.

Suitably, the degree of identity with regard to a nucleotide sequence is determined over at least 20 contiguous nucleotides, preferably over at least 30 contiguous nucleotides, preferably over at least 40 contiguous nucleotides, preferably over at least 50 contiguous nucleotides, preferably over at least 60 contiguous nucleotides, preferably over at least 100 contiguous nucleotides.

Suitably, the degree of identity with regard to a nucleotide sequence is determined over at least 100 contiguous nucleotides, preferably over at least 200 contiguous nucleotides, preferably over at least 300 contiguous nucleotides, preferably over at least 400 contiguous nucleotides, preferably over at least 500 contiguous nucleotides, preferably over at least 600 contiguous nucleotides, preferably over at least 700 contiguous nucleotides, preferably over at least 800 contiguous nucleotides.

Suitably, the degree of identity with regard to a protein (amino acid) sequence is determined over at least 100 contiguous amino acids, preferably over at least 200 contiguous amino acids, preferably over at least 300 contiguous amino acids.

For example, the degree of identity with regard to the amino acid sequence of a fragment may be determined over the length of the fragment sequence. In other words, the degree of identity with regard to the amino acid sequence of a fragment may be determined over the length of the shorter sequence.

Preferably, the degree of identity with regard to an amino acid or protein sequence may be determined over the whole mature sequence taught herein, such as over SEQ ID NO:1 disclosed herein.

In the present context, the term “query sequence” means a homologous sequence or a foreign sequence, which is aligned with a subject sequence in order to see if it falls within the scope of the present invention. Accordingly, such query sequence can for example be a prior art sequence or a third party sequence.

In one preferred embodiment, the sequences are aligned by a global alignment program and the sequence identity is calculated by identifying the number of exact matches identified by the program divided by the length of the subject sequence.

In one embodiment, the degree of sequence identity between a query sequence and a subject sequence is determined by 1) aligning the two sequences by any suitable alignment program using the default scoring matrix and default gap penalty, 2) identifying the number of exact matches, where an exact match is where the alignment program has identified an identical amino acid or nucleotide in the two aligned sequences on a given position in the alignment and 3) dividing the number of exact matches with the length of the subject sequence.

In yet a further preferred embodiment, the global alignment program is selected from the group consisting of CLUSTAL and BLAST (preferably BLAST) and the sequence identity is calculated by identifying the number of exact matches identified by the program divided by the length of the subject sequence.

The sequences, such as variant sequences or catalase active fragments thereof, may also have deletions, insertions or substitutions of amino acid residues which produce a silent change and result in a functionally equivalent substance. Deliberate amino acid substitutions may be made on the basis of similarity in polarity, charge, solubility, hydrophobicity, hydrophilicity, and/or the amphipathic nature of the residues as long as the secondary binding activity of the substance is retained. For example, negatively charged amino acids include aspartic acid and glutamic acid; positively charged amino acids include lysine and arginine; and amino acids with uncharged polar head groups having similar hydrophilicity values include leucine, isoleucine, valine, glycine, alanine, asparagine, glutamine, serine, threonine, phenylalanine, and tyrosine.

Conservative substitutions may be made, for example according to the Table below. Amino acids in the same block in the second column and preferably in the same line in the third column may be substituted for each other as set forth in Table 3.

TABLE 3

| | | |
|---|---|---|
| ALIPHATIC | Non-polar | G A P |
| | | I L V |
| | Polar - uncharged | C S T M |
| | | N Q |
| | Polar - charged | D E |
| | | K R |
| AROMATIC | | H F W Y |

The present invention also encompasses homologous substitution (substitution and replacement are both used herein to mean the interchange of an existing amino acid residue, with an alternative residue) that may occur i.e. like-for-like substitution such as basic for basic, acidic for acidic, polar for polar etc. Non-homologous substitution may also occur, i.e. from one class of residue to another or alternatively involving the inclusion of unnatural amino acids such as ornithine (hereinafter referred to as Z), diaminobutyric acid ornithine (hereinafter referred to as B), norleucine ornithine (hereinafter referred to as O), pyriylalanine, thienylalanine, naphthylalanine and phenylglycine.

Replacements may also be made by synthetic amino acids (e.g. unnatural amino acids) include; alpha* and alpha-disubstituted* amino acids, N-alkyl amino acids*, lactic acid*, halide derivatives of natural amino acids such as trifluorotyrosine*, p-Cl-phenylalanine*, p-Br-phenylalanine*, p-l-phenylalanine*, L-allyl-glycine*, β-alanine*, L-a-amino butyric acid*, L-g-amino butyric acid*, L-a-amino isobutyric acid*, L-e-amino caproic acid #, 7-amino heptanoic acid*, L-methionine sulfone^{#}*, L-norleucine*, L-norvaline*, p-nitro-L-phenylalanine*, L-hydroxyproline^{#}, L-thioproline*, methyl derivatives of phenylalanine (Phe) such as 4-methyl-Phe*, pentamethyl-Phe*, L-Phe (4-amino)^{#}, L-Tyr (methyl)*, L-Phe (4-isopropyl)*, L-Tic (1,2,3,4-tetrahydroisoquinoline-3-carboxyl acid)*, L-diaminopropionic acid # and L-Phe (4-benzyl)*.

The notation * has been utilised for the purpose of the discussion above (relating to homologous or non-homologous substitution), to indicate the hydrophobic nature of the derivative whereas # has been utilised to indicate the hydrophilic nature of the derivative, #* indicates amphipathic characteristics.

Variant amino acid sequences may include suitable spacer groups that may be inserted between any two amino acid residues of the sequence including alkyl groups such as methyl, ethyl or propyl groups in addition to amino acid spacers such as glycine or b-alanine residues. A further form of variation, involves the presence of one or more amino acid residues in peptoid form, will be well understood by those skilled in the art. For the avoidance of doubt, “the peptoid form” is used to refer to variant amino acid residues wherein the a-carbon substituent group is on the residue's nitrogen atom rather than the a-carbon. Processes for preparing peptides in the peptoid form are known in the art, for example Simon R J et al., PNAS (1992) 89(20), 9367-9371 and Horwell D C, Trends Biotechnol. (1995) 13(4), 132-134.

The nucleotide sequences for use in the present invention may include within them synthetic or modified nucleotides. A number of different types of modification to oligonucleotides are known in the art. These include methylphosphonate and phosphorothioate backbones and/or the addition of acridine or polylysine chains at the 3′ and/or 5′ ends of the molecule. For the purposes of the present invention, it is to be understood that the nucleotide sequences described herein may be modified by any method available in the art. Such modifications may be carried out in order to enhance the in vivo activity or life span of nucleotide sequences of the present invention.

The present invention also encompasses the use of nucleotide sequences that are complementary to the sequences presented herein.

Other variants of the sequences described herein may be obtained for example by probing DNA libraries made from a range of individuals, for example individuals from different populations. In addition, other homologues may be obtained and such homologues and fragments thereof in general will be capable of selectively hybridising to the sequences shown in the sequence listing herein. Such sequences may be obtained by probing cDNA libraries made from or genomic DNA libraries from other animal species, and probing such libraries with probes comprising all or part of any one of the sequences in the attached sequence listings under conditions of medium to high stringency. Similar considerations apply to obtaining species homologues and allelic variants of the polypeptide or nucleotide sequences of the invention.

Variants and strain/species homologues may also be obtained using degenerate PCR which will use primers designed to target sequences within the variants and homologues encoding conserved amino acid sequences within the sequences of the present invention. Conserved sequences can be predicted, for example, by aligning the amino acid sequences from several variants/homologues. Sequence alignments can be performed using computer software known in the art. For example, the GCG Wisconsin PileUp program is widely used.

The primers used in degenerate PCR will contain one or more degenerate positions and will be used at stringency conditions lower than those used for cloning sequences with single sequence primers against known sequences.

Alternatively, such polynucleotides may be obtained by site directed mutagenesis of characterised sequences. This may be useful where for example silent codon sequence changes are required to optimise codon preferences for a particular host cell in which the polynucleotide sequences are being expressed. Other sequence changes may be desired in order to introduce restriction enzyme recognition sites, or to alter the property or function of the polypeptides encoded by the polynucleotides.

### Glucose-Oxidase Activity

In one aspect of the invention as described herein, the catalase composition may also comprise glucose oxidase (GOX) activity.

In one aspect the GOX represents a side-activity to the catalase, for example in the event that the catalase is expressed in a host cell such as T. reesei, wherein a GOX side-activity remains in the catalase composition.

In one aspect the ratio of glucose oxidase: catalase activity may be more than 0.001, more preferably more than 0.0001 and even more preferably more than 0.00001.

In one aspect, the GOX may have the sequence of SEQ ID NO: 5 (T. reesei GOX) or a variant, derivative, homologue or active fragment thereof as described herein.

A glucose-oxidase Unit (GODU) is the amount of enzyme, which oxidizes 1 pmol of beta-D-Glucose per minute. Glucose-oxidase (beta-D-glucose: oxygen-1-oxido-reductase, EC 1.1.3.4.) oxidises beta-D-glucose in the presence of oxygen to delta-glucono-lactone and hydrogen-peroxide. The generated hydrogen-peroxide oxidises ABTS-R (2, 2-Azino-di-(3-ethylbenzthiazoline)-6-sulfonate) in the presence of peroxidase (POD). This generates a green-blue colour, which is measured photometrically at 405 nm.
Beta-D-glucose+O₂ GOD, 30° C., pH 5.6->Delta-glucono-lactone+H₂O₂
H₂O₂+ABTS_{red} POD->2H₉O+ABTSᵣ

### Reaction Conditions:

Substrate Glucose 90 mM (16.2 g/l)
ABTS 1.25 mM (688 mg/l)
Glucose-oxidase 0.0061-0.0336 GODU/ml
Peroxidase (POD) 2930 U/l
Buffer Acetate, 100 mM
PH 5.60±0.05
Temperature 30° C.±1 Reaction time 36 sec. (8×4.5 sec.)
Wavelength 405 nm

### Additional Enzymes

In one aspect of the invention as described herein, additional enzymes may be used during the brewing process.

For example, a proline-specific protease may be used, for example for reduction or elimination of beer haze. Suitable proline-specific proteases will be known to those of skill in the art.

In one aspect, the proline-specific protease is an enzyme having at least 75, 80, 85, 90, 95, 98, 99 or 100% sequence identity to any of SEQ ID NO: 6, SEQ ID NO: 7, SEQ ID NO: 8, SEQ ID NO: 9, SEQ ID NO: 10, SEQ ID NO: 11, SEQ ID NO: 12 and SEQ ID NO: 13 or an active fragment thereof.

The method may also involve adding one or more of an ALDC (alpha acetolactate decarboxylase) enzyme, a glucoamylase, a maltogenic alpha-amylase, a pullulanase, or a transglucosidase. Optionally, the ALDC enzyme is an acetolactate decarboxylase as set forth in EC 4.1.1.5. Optionally, the glucoamylase is a 1,4-alpha-glucosidase as set forth in EC 3.2.1.3. Optionally, the maltogenic alpha amylase is a glucan 1,4-alpha-maltohydrolase as set forth in EC 3.3.1.133. Optionally, the pullulanase is an alpha-dextrin endo-1,6-alpha-glucosidase, limit dextrinase, amylopectin 6-glucanohydrolase, debranching enzyme as set forth in EC 3.2.1.41. Optionally, the transglucosidase is 1,4-alpha-glucan-branching enzyme, Oligoglucan-branching glucosyltransferse as set forth in EC 2.4.1.24.

The present invention employs, unless otherwise indicated, conventional techniques of biochemistry, molecular biology, microbiology and recombinant DNA, which are within the capabilities of a person of ordinary skill in the art. Such techniques are explained in the literature. See, for example, J. Sambrook, E. F. Fritsch, and T. Maniatis, 1989, Molecular Cloning: A Laboratory Manual, Second Edition, Books 1-3, Cold Spring Harbor Laboratory Press; Ausubel, F. M. et al. (1995 and periodic supplements; Current Protocols in Molecular Biology, ch. 9, 13, and 16, John Wiley & Sons, New York, N. Y.); B. Roe, J. Crabtree, and A. Kahn, 1996, DNA Isolation and Sequencing: Essential Techniques, John Wiley & Sons; M. J. Gait (Editor), 1984, Oligonucleotide Synthesis: A Practical Approach, Irl Press; and, D. M. J. Lilley and J. E. Dahlberg, 1992, Methods of Enzymology: DNA Structure Part A: Synthesis and Physical Analysis of DNA Methods in Enzymology, Academic Press. Each of these general texts is herein incorporated by reference.

The present disclosure is described in further detail in the following examples, which are not in any way intended to limit the scope of the disclosure as claimed. The attached figures are meant to be considered as integral parts of the specification and description of the disclosure. The following examples are offered to illustrate, but not to limit the claimed disclosure.

### Strecker Aldehydes

The present invention also encompasses a reduction in the level of Strecker aldehydes in the resulting beer. Flavor is the main quality characteristic of beer and is important for brand recognition and identification. One well-established observation during beer staling is the increase of aldehydes or so-called Strecker aldehydes, and these have been shown to be associated with off-flavor in beer. In a further aspect of the invention, adding the catalase composition after mash boiling and/or during or after wort preparation and/or fermentation and/or maturation and/or stabilization and/or pasteurization of the beer, or to the final beer itself reduces the generation of Strecker aldehydes. The Strecker aldehydes may include, but are not limited to, 2-Butenal, Hexanal, trans-3-Penten-2-one, 4-Hexen-3-one, Nonanal, Furfural, Decanal, trans-2-Nonenal, Benzaldehyde, Phenylacetaldehyde and Ethylnicotinate.

In preferred aspect of the invention the Strecker aldehydes may be reduced by adding a catalase composition to the beer, including a reduction in the generation of trans-2-Nonenal and/or benzaldehyde by at least 10%, at least 20%, at least 30%, at least 40%, or at least 50%.

### Example 1—Enzymes

A highly active catalase preparation from Aspergillus niger having the amino acid sequence shown in SEQ ID NO: 1 (available from IFF, Food Enzymes, Denmark). The catalase preparation holds 1,000 (Baker) Units/g where 1 Baker Unit is defined as that amount of catalase which will decompose 264 mg hydrogen peroxide at a “double exhaustion” analysis based on the simultaneous inactivation of catalase by hydrogen peroxide and the breakdown of hydrogen peroxide by catalase after 60 minutes incubation at pH 7.0 and 25.0° C.

In addition, another highly active catalase preparation from Trichoderma reesei that also possesses the amino acid sequence shown in SEQ ID NO: 1 (available from IFF, Food Enzymes, Denmark) was utilized, with 9,250 Units/g. It is selectively specified in the below examples when the catalase from Trichoderma reesei (catalase-2) was utilized, while in all other examples the catalase preparation from Aspergillus niger (catalase-1) was used.

### Example 2—Determination of Catalase Activity

Catalase activity was determined using the catalase assay procedure “K-CATAL 07/19” supplied by Megazymes, Ireland. In this assay, the activity of catalase was evaluated based on the decrease in H₂O₂. Two separate reactions are needed. In the first reaction, the catalase sample is mixed with a known concentration of H₂O₂ (˜65 mM). After a set time, the reaction is stopped with 15 mM sodium azide, which inhibits the catalase. In the second reaction, the remaining H₂O₂ is measured using 3,5-dicholro-2-hydroxy-benzensulfonic acid (DHBS), 4-aminoantipyrine (AAP) and peroxidase, which provides an enzyme-linked colorimetric detection at 520 nm. As a control, a blank reaction is performed simultaneously. In this manner, 50 μl substrate solution (165 mM H₂O₂, prepared according to Megazyme) was mixed with 50 μl catalase solution diluted in reaction assay buffer (150 mM Potassium phosphate buffer pH 7.0, supplied by Megazyme) and incubated for 5 minutes at 25° C. in an iEMS incubator/shaker (Thermo Scientific, Rockford, IL, USA). To stop the reaction, 20 μl of the reaction solution was mixed with 180 μl 15 mM sodium azide and then 3 μl of the stopped reaction solution was mixed with 225 μl of Colourimetric Reagent Solution (Peroxidase, 4-aminoantipyrine and 3,5-Dichloro-2-hydroxybenzenesulfonate (DHBS) solution supplied by Megazyme). The colourimetric reaction was incubated for 15 minutes at 25° C. in iEMS incubator/shaker and absorbances at 520 nm were recorded for the blank sample and catalase reaction sample using a SpectraMAX MTP Reader (Molecular Devices, Sunnyvale, CA, USA).

### Example 3—Determination of Catalase Activity in Beer after Pasteurization

To assess the impact of pasteurization on catalase activity after beer fermentation, 660 μl of the catalase preparation as set forth in SEQ ID NO: 1 (1000 U/g), was added to a regular 330 ml pilsner-type beer (Carlsberg, Denmark, 4.6% (v/v) alc.) resulting in 2 U/mL beer. The beer was incubated in a water bath at 62.1° C. Samples were withdrawn at 0, 10, 20, 30, 40, 45, 50 and 55 minutes during pasteurization of the Carlsberg beer.

To measure enzyme thermostability under the conditions used in the present experiments, catalase activity was determined before and after pasteurization of the beer, according to example 2. Beer without catalase added was used as a control. The accumulated energy input was converted into pasteurization units (PU and accumulated PU), an energy equivalent index, as calculated by the equation below.

Pasteurization units or PU refers to a quantitative measure of pasteurization. One pasteurization unit (1 PU) for beer is defined as a heat retention of one minute at 60 degrees Celsius. One calculates that:

PU=t×1.393\hat{ }(T), where:
t=time, in minutes, at the pasteurization temperature
T=temperature, in degrees Celsius, of pasteurization—60° C. here
[\hat{ }(T) represents the exponent of (T)]

Thus, thermostability of the catalase in regular Carlsberg pilsner (Denmark, 4.6% (v/v) alc.) was determined. Data was calculated as % relative activity as compared to activity determined at pasteurization time 0, with results shown in table 4. It was clear that the catalase preparation as set forth in SEQ ID NO: 1, is sufficiently thermostable to survive (98.7% residual activity) a 24 PU pasteurization performed at a temperature up to 62° C.

TABLE 4
Residual catalase activity in beer after pasteurization. Temperature
inside the beer bottle in ° C., pasteurization time in
minutes, accumulated PU, Catalase activity in delta Abs520
nm and residual catalase activity relative to time 0.

| | | | delta | Residual |
|---|---|---|---|---|
| Inside bottle, ° C. | time, min | Acc. PU | Abs520 nm | activity |
| 19.0 | 0 | — | 0.699 | 100 |
| 30.0 | 10 | 0.0 | 0.699 | 100 |
| 39.7 | 20 | 0.0 | 0.699 | 100 |
| 48.7 | 30 | 0.2 | 0.699 | 100 |
| 58.0 | 40 | 5.4 | 0.699 | 100 |
| 61.0 | 45 | 12.4 | 0.691 | 98.9 |
| 61.8 | 50 | 14.5 | 0.688 | 98.4 |
| 62.1 | 55 | 24.5 | 0.690 | 98.7 |

### Example 4—Electron Spin Resonance (ESR) Measurements: Endogenous Antioxidative Potential and T600 Determination

The functional principle of EAP determination is based on application of the specific spin trap reagent α(4-pyridyl-1-oxide)-N-tert-butylnitrone (POBN), which decreases distortions of the so-called lag-time values in beer caused by the former spin trap reagent α-pyridyl-N-tert-butylnitrone (PBN) through a pH effect on the radical generation (16,38).

The following ESR spectrometer was used for the lag time measurement by means of PBN and for the EAP determination by means of POBN: X-band spectrometer; Bruker (ESP-300); cavity type: Bruker 4108 TMH No: 8603 and X-band spectrometer; Magnettech Miniscope MS 100. The irradiation experiments concerning the artificial generation of radicals were carried out by means of X-ray irradiation (X-ray tube from Seifert Debyflex). The term “X-ray system” for the generation of radicals, as used here, describes the artificial generation of radicals via ionizing radiation (X-ray radiation), as known in the prior art.

### Reagents

N-tert-butyl-α-(4-pyridyl)nitrone N-oxide (POBN) 99%, C10H14N2O2, 194.23 g/mol (Sigma Aldrich, 1 g, at least 99%, No. 215430, CAS No. 66893-81-0, EC No. 266-512-3).

Ethanol pro analysis 99.8%, C₂H₅OH, 46.07 g/mol, density: 1 litre=0.79 kg (Merck Darmstadt); The determination of the endogenous antioxidative potential (EAP value) using ESR spectroscopy is based on the indirect detection of the radical generation during accelerated beer ageing (60° C.). For a certain period of time, the radical generation can be delayed or prevented by the endogenous antioxidative activity of beer. After consumption of antioxidants, the ESR signal increases when spin-trap adducts are formed, mainly hydroxyethyl radicals. The intersection of the two linear slopes gives a relative measure of the stability and the time at the intersection is defined as the EAP value (Deutsches Patent und Markenamt DE 10 2005 043 113 A1, 2005. Patent US 20080248580, Method for determining the Endogenous Antioxidative Potential of beverages by means of ESR spectroscopy, 2008). The T600 value is defined as the ESR signal intensity after 600 min assay and indicates qualitatively the content of radicals that are generated under forced ageing conditions (60° C.) (Deutsches Patent und Markenamt DE 10 2005 043 113 A1, 2005. Patent US 20080248580, Method for determining the Endogenous Antioxidative Potential of beverages by means of ESR spectroscopy, 2008).

Beer samples were degassed in an ultrasonic bath for 15 min (max. 20° C.). For each sample, 8.4 mg of POBN was diluted in 50 μl of double distilled water (final 3.5-3.6 mM POBN). For the preparation of ESR beer samples, amber vials were used containing 156 μl of ethanol (99%) and 12 ml of beer sample. Directly at the start of the measurement, 52 μl of the POBN solution was added and the enzyme sample 0.5 ml was placed in the auto sampler, total volume 12.708 ml, at 60° C. For the preparation of ESR wort samples, amber vials were used containing 10 ml malt-based wort extract and 700 μl ethanol. Directly at the start of the measurement, 105 μl POBN solution was added, and the enzyme sample 0.5 ml solution was placed in the auto sampler, total volume 11.305 ml, at 60° C.

### Example 5—ESR Analysis of Catalase in Malt Extract

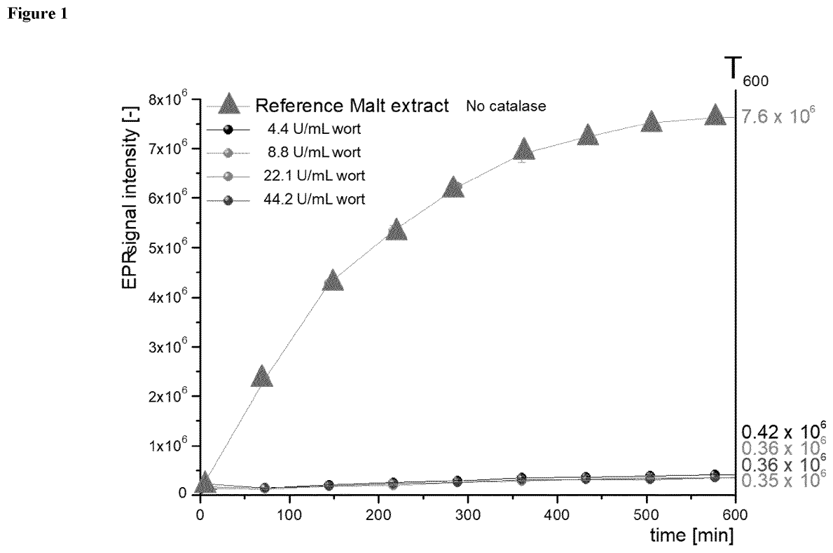

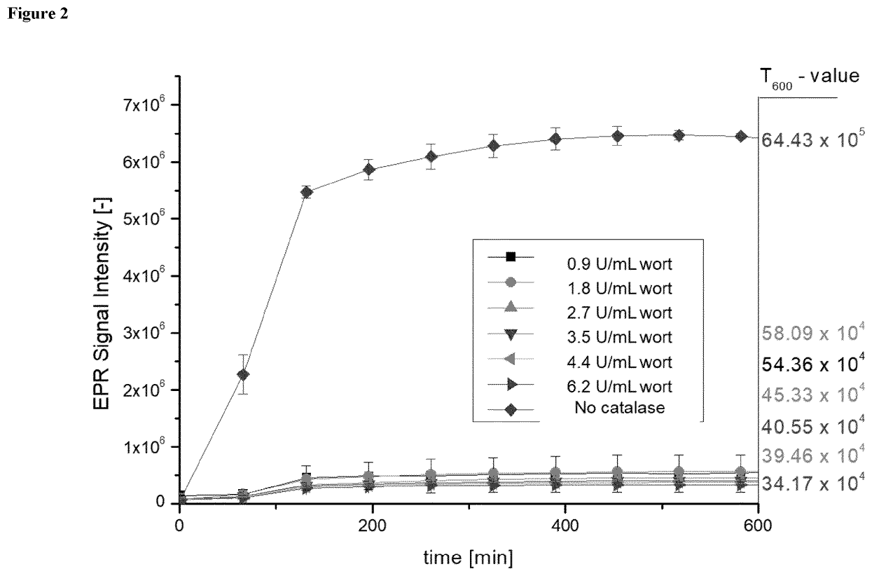

To assess the impact of the catalase during beer fermentation, various catalase as set forth in SEQ ID NO: 1, were prepared in double distilled water in various dilutions and added to wort samples and analyzed by ESR. For the preparation of ESR wort samples, amber vials were used containing 10 ml malt-based wort extract, 700 μl ethanol and before the start of the measurement, 105 μl POBN solution and 0.5 ml of the diluted enzyme sample was added and the solution was placed in the auto sampler, total volume 11.305 ml, at 60° C. The results of various catalase additions into wort in shown in both FIG. 1 (0.0 to 44.2 U/ml) and FIG. 2 (0.0 to 6.2 U/ml) in various dosages. Surprisingly, all dosages from even very low level of catalase (0.9 U/ml wort) showed a very good oxidative protection and complete lowering of the ESR signal. The T600 was lowered by catalase addition from 7.6×10⁶ to 0.35×10⁶ (FIG. 1) and 64.43×10⁵ to 34.17×10⁴ (FIG. 2), without any assignable EAP, clearly suggesting the catalase can act on prooxidative radical generation by lowering hydrogen peroxide formed in wort however will not provide increased endogenous antioxidative potential (EAP). Thus, addition of catalase during beer fermentation in wort may significantly improve the oxidative stability of the wort and final beer.

### Example 6—ESR Analysis of Catalase in Dark Coloured Pilsner with Low EAP

It is well known that the temperature during the withering and kilning steps in malt production increase generation of stable organic radicals in the finished malt consequently reducing the endogenous antioxidant potential value and sulfur dioxide content of the final beer. To assess the impact of the catalase to a beer with low endogenous antioxidant potential value, various catalase as set forth in SEQ ID NO:1, were prepared in double distilled water in various dilutions and added dark pilsner (Kostritzer pilsner, 4.6% (v/v) alc., Germany) samples and analyzed by ESR. For the preparation of ESR beer samples, amber vials were used containing 156 μl of ethanol (99%) and 12 mL of de-gassed beer sample.

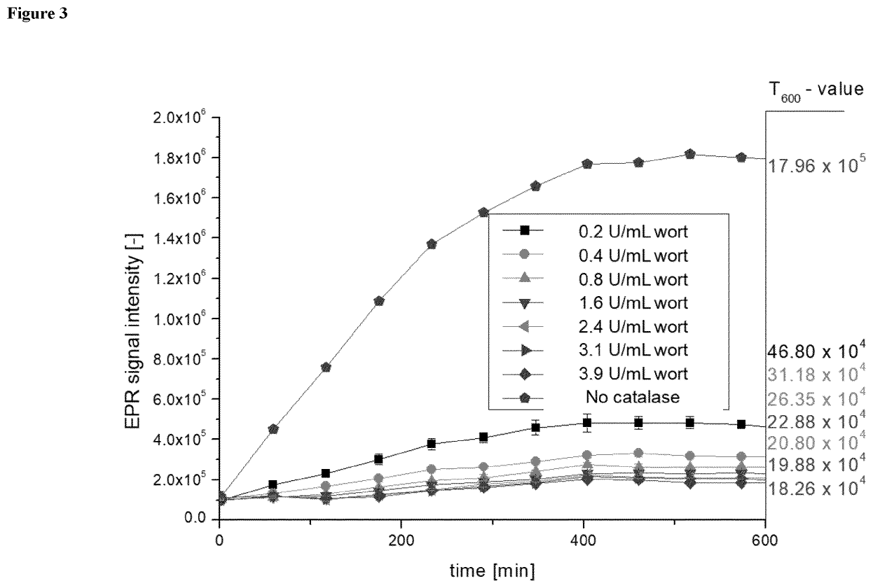

Directly at the start of the measurement, 52 μl of the POBN solution was added and the diluted enzyme sample 0.5 ml was placed in the auto sampler at 60° C., with a total volume of 12.708 ml. The results of various catalase additions into the dark pilsner with low EAP is shown in FIG. 3 (0.0 to 3.9 U/ml). A very clear effect of the catalase was observed showing a very good oxidative protection and lowering of the ESR signal. Beer sample without catalase showed increase of ESR signal over time with no assignable EAP. The addition of even 0.2 U/ml catalase showed very significant reduction of the ESR signal (lowering of T600 from 17.96×10⁵ to 46.80×10⁴) and addition of more than 0.8 U/ml catalase showed complete reduction of the ESR signal (lowering of T600 from 17.96×10⁵ to 26.35×10⁴). These results clearly indicate that addition of catalase to beer with low oxidative stability may greatly improve taste and shelf-life.

### Example 7—ESR Analysis of Catalase in Beer with EAP

To assess the impact of the catalase to a beer with medium endogenous antioxidant potential, various catalase dilutions as set forth in SEQ ID NO: 1, were prepared in double distilled water in various dilutions and added to pilsner beer (Heineken pilsner, 4.6% (v/v) alc., Germany and Becks, 4.6% (v/v) alc., Germany) samples and analyzed by ESR.

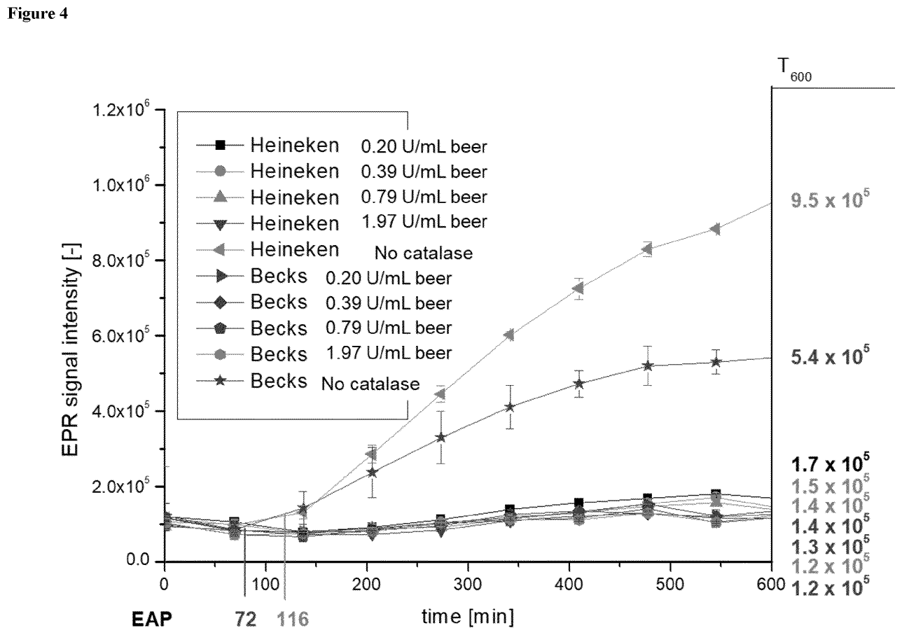

For the preparation of ESR beer samples, amber vials were used containing 182 μl of ethanol (99%) and 14 ml of de-gassed beer sample. Directly at the start of the measurement, 61 μl of the POBN solution was added and the diluted enzyme sample 0.5 ml was placed in the auto sampler at 60° C., with a total volume of 14.743 ml. The results of various catalase additions into the dark pilsner with low EAP is shown in FIG. 4 (0.0 to 1.97 U/ml). A clear effect of the catalase was observed showing a very good oxidative protection and lowering of the ESR signal. The addition of even 0.2 U/ml catalase showed complete reduction of the ESR signal (lowering of T600 from 9.5×10⁵ to 1.7×10⁵). These results clearly indicate that additional of catalase to beer with medium oxidative stability (EAP of 72 and 116 min.) may greatly improve the stability and hereby taste and shelf-life of the beer.

### Example 8—ESR Analysis of Catalase in Beer with Low SO₂ Content in Storage Stability Trials

To assess the impact of catalase addition to a beer with unknown endogenous antioxidant potential but low SO₂, catalase with SEQ ID NO: 1 was prepared in double distilled water in a range of dilutions and added two pilsner beer samples (Odense pilsner, 4.6% (v/v) alc., Denmark and Tuborg pilsner, 4.5% (v/v) alc., Denmark) and analyzed by ESR after storage. After catalase addition, the samples were gassed with CO₂ and then stored for one month at 28° C. After one month, ESR spectroscopy and staling aldehyde determination were carried out.

The following concentrations and samples were utilised:
1. Odense (fresh, no storage) without any addition
2. Tuborg (fresh, no storage) without any addition
3. Odense+650 μl catalase with SEQ ID NO: 1, corresponding to 0.19 U/ml (one month at 28° C.)
4. Tuborg+650 μl H₂O (one month at 28° C.)
5. Odense+650 μl H₂O (one month at 28° C.)
6. Tuborg+650 μl catalase with SEQ ID NO: 1, corresponding to 0.19 U/ml (one month at 28° C.)

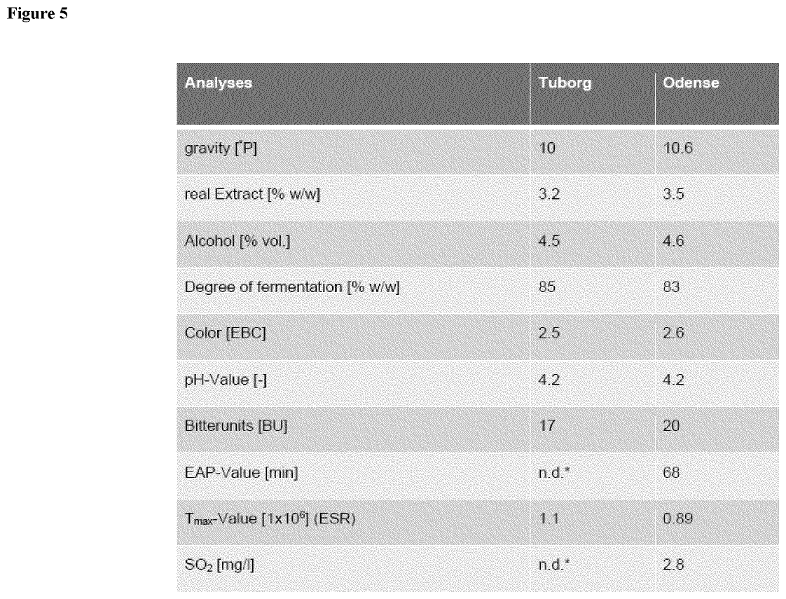

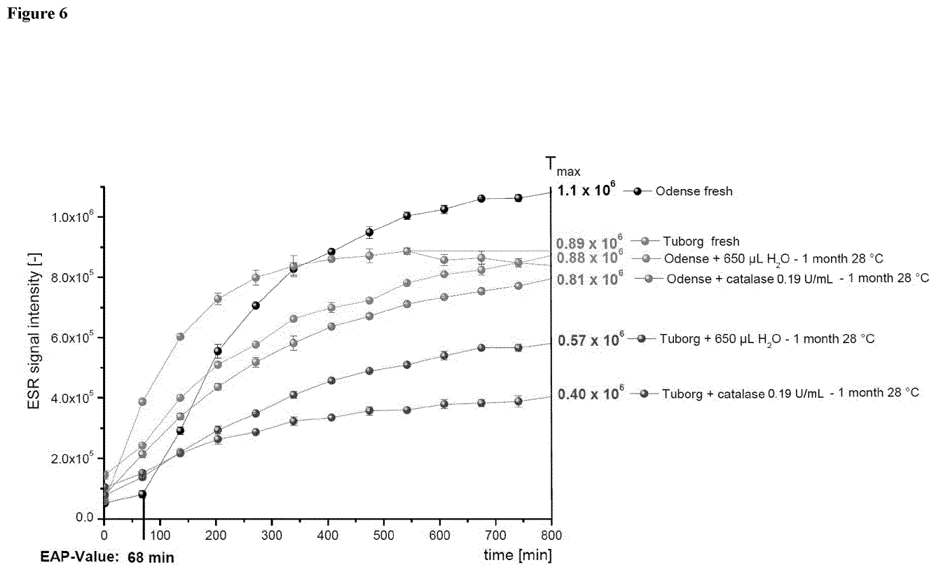

The standard beer characteristics of the Tuborg and Odense samples were measured according to the regulations of the “Mitteleuropaischen Brautechnischen Analyse Kommission” (MEBAK; Brautechnische Analysenmethoden. Würze, Bier, Biermischgetränke/herausgegeben vom Vorsitzenden Prof. Fritz Jacob, MEBAK, Freising-Weihenstephan, 2012), as shown in FIG. 5 for fresh beer. These show that fresh Tuborg pilsner possessed a gravity of 10° P, a real extract of 3.2% w/w, an alcohol content by volume of 4.5% v/v, a fermentation degree of 85%, a colour of 2.5 EBC, a pH of 4.2, bitter units of 17 BU, an EAP value which was not determinable, a Tmax value of 1.1×10⁶ and also and SO₂ value which was not determinable. The fresh Odense possessed a gravity of 10.6, a real extract of 3.5, an alcohol content by volume of 4.6% v/v, a fermentation degree of 83%, colour of 2.6 EBC, pH value of 4.2, bitter units of 20 BU, an EAP value of 68, a Tmax value of 0.89×10⁶ and an SO₂ content of 2.8 mg/l. ESR analysis of beer samples was carried out as described in example 7 and result are shown in FIG. 6. Here the highest signal intensity was possessed by fresh Odense with a Tmax of 1.1×10⁶ and an EAP value of 68 min, followed by fresh Tuborg with a Tmax of 0.89×10⁶. Odense stored for one month had a Tmax value of 0.88×10⁶, followed by Odense with catalase added with a Tmax of 0.8×10⁶. The second lowest Tmax values were seen in Tuborg stored for one month with a Tmax of 0.57×10⁶, followed by the Tuborg with catalase added with a Tmax of 0.40×10⁶. Even with this very low dose (0.19 U/ml) of catalase and one month's storage at 28° C., a clear improvement in oxidative stability was observed, given the significant differences in T800 values when beer samples with or without catalase added were compared.

### Example 9—Using Catalase in During Brewing Mashing Process and ESR Analysis of Wort Samples

To investigate the action of the catalase during mashing, various amounts of catalase with SEQ ID NO: 1 were tested in a lab-scale malt-based mashing setup and the resulting worts analysed by ESR to score their oxidative stability.

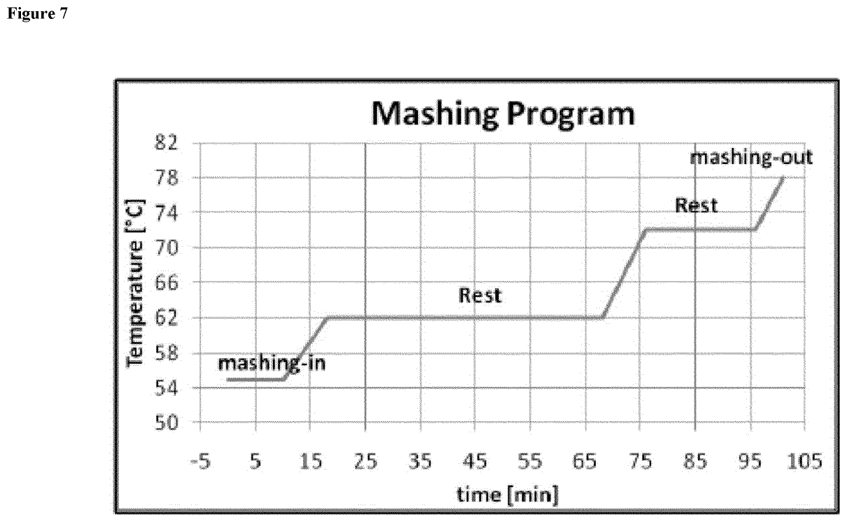

During the mashing trial, mixes resulting in a dark beer wort were used. For these mixes, 3.75 g Caraaroma malt and 71.25 g pilsner malt were mixed with 375 ml double-distilled water. Afterwards these were mashed according to FIG. 7.

Samples with catalase added were mixed with the catalase before mashing in. The following mash samples were generated for the trial:

Dark beer mashes (375 ml total volume):
1. 95% Pilsner Malt+5% Caraaroma
2. 95% Pilsner Malt+5% Caraaroma malt+0.63 U/ml catalase (A. niger)
3. 95% Pilsner Malt+5% Caraaroma malt+1.26 U/ml catalase (A. niger)
4. 95% Pilsner Malt+5% Caraaroma malt+0.63 U/ml catalase (T. reesei)
5. 95% Pilsner Malt+5% Caraaroma malt+1.26 U/ml catalase (T. reesei)

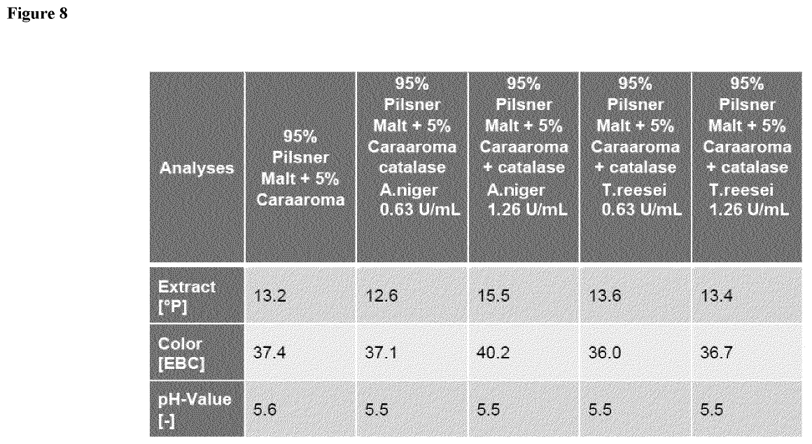

Samples were taken after lautering and whirlpool rest and then investigated via ESR spectroscopy and beer analysis using a Precision densimeter DMA 4500M (Alcoholizer ME, colour- & pH-module, Anton Paar GmbH, AT-8054 Graz) according to MEBAK (real extract: Vol. II 2.9.6.3, colour: Vol. II 2.12.2 and pH: Vol. II 2.13). Results of wort analysis are shown in FIG. 8. Here the wort without catalase addition had an extract of 13.2° P, a colour of 37.4 EBC and a pH of 5.6. The wort with 0.63 U/ml catalase (A. niger) added obtained an extract of 12.6° P, a colour of 37.1 EBC and a pH of 5.5, whereas the wort with 1.23 U/ml catalase (A. niger) had an extract of 15.5° P, a colour of 40.2 EBC and a pH of 5.5. Additionally, the wort with 0.63 U/mL catalase (T. reesei) added obtained an extract of 13.6° P, a colour of 36 EBC and a pH value of 5.5 whereas the wort with 1.23 U/ml catalase (T. reesei) added had an extract of 13.4° P, 36.7 EBC and a pH value of 5.5.

For the controls, either 0.63 U/mL catalase (T. reesei) or 0.63 U/ml catalase (A. niger) was added to the dark beer wort after wort boiling.

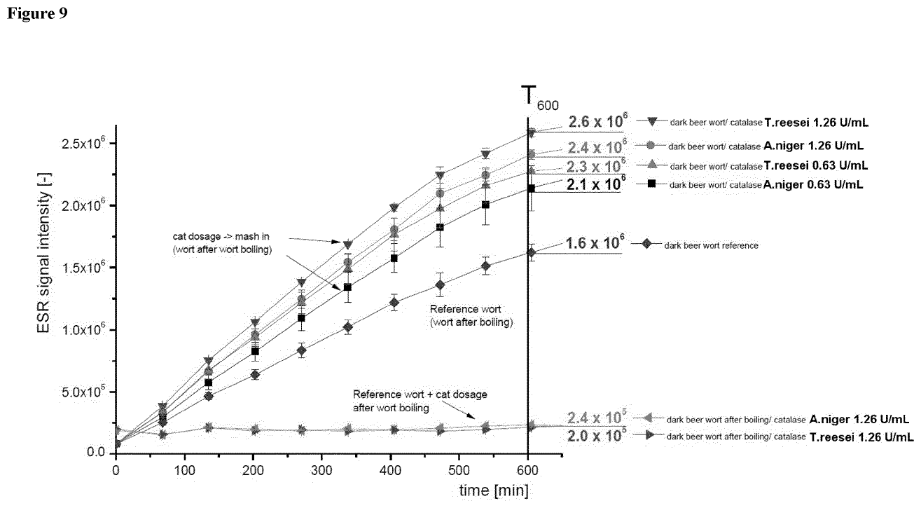

FIG. 9 shows T600 value determination via ESR spectroscopy of the mashing trial dark beer worts, including a control with catalase added to dark beer wort after wort boiling.

The wort with 1.26 U/ml catalase (T. reesei) added obtained the highest signal intensity of 2.6×10⁶, followed by the wort with 1.26 U/ml catalase (A. niger) added and a signal intensity of 2.4×10⁶. The wort with 0.63 U/ml catalase (T. reesei) added had a signal intensity of 2.3×10⁶, and the wort with 0.63 U/ml catalase (A. niger) added had a signal intensity of 2.1×10⁶. For comparison, a signal intensity of 1.6×10⁶ was obtained from the reference wort. The second lowest signal intensity of 2.4×10¹ was obtained from wort with 0.63 U/ml catalase (T. reesei) added after boiling, whereas the lowest signal intensity of 2.0×10¹ was obtained from the wort with 0.63 U/ml catalase (A. niger) added after boiling. Thus, it is highly surprising that the addition of catalase during mashing resulted in a negative effect on oxidative stability, with high T600 values in ESR analysis. This clearly indicates that catalase added during mashing results in a beer with markedly lower oxidative stability and therefore potential improvements in taste change while reducing shelf-life of the beer. If catalase was added to the final wort after mashing, e.g. similar to addition during fermentation of the beer, the results instead indicate that addition of catalase greatly improve the beer/wort stability and therefore shelf-life of the resulting beer. The conditions and timing under which catalase is added to the brewing process are critical to the enzyme's function.

### Example 10—Analysis of Accelerated Oxidative Off-Flavour Generation in Beer by GC-MS

Flavour is the main quality characteristic of beer and is important for brand recognition and identification. One well-established observation during beer staling is the increase of aldehydes or so-called Strecker aldehydes, and these have been shown to be associated with off-flavour in beer. Oxygen and oxidation have been shown to significantly promote Strecker aldehyde formation in beer. In this example conditions for accelerated off-flavour generation were tested in a regular pilsner-type beer (Carlsberg, Denmark, 4.6% (v/v) alc.).

Freshly produced Carlsberg, Denmark, 4.6% (v/v) alc. (within one month of production) was gently opened and the head space of 33cl. beer bottles air-flushed to exchange the headspace CO₂ with atmospheric air. Bottles were left open 20 seconds and then firmly closed with crown cork. To ensure homogeneous oxidation, the bottle was repeatedly inverted for 1 minute to ensure mixing of liquid with headspace oxygen. An un-opened control was kept at room temperature (RT) for 14 days. Following headspace oxidation, beer samples were incubated at either 30° C. or 60° C. for up to 14 days to accelerate oxidation. The following 6 treatments were then carried out and analyzed for off-flavour generation by GC-MS-SPME:
FL.Blank—Carlsberg pilsner stored at RT and not opened
FL.1—Carlsberg pilsner_flushed 30° C._1 Day
FL.2—Carlsberg pilsner_flushed 30° C._3 Days
FL.3—Carlsberg pilsner_flushed 30° C._7 Days
FL.4—Carlsberg pilsner_flushed 30° C._14 Days
FL.5—Carlsberg pilsner_flushed 60° C._5 Days

Volatile off-flavours were quantified by SPME-GCMS which was performed in full scan and SIM mode with a carboxen/PDMS-fiber as described below.

### Analysis of Volatiles

Each treatment sample (1.0 g) was weighed in a 22 ml-headspace vial. A standard solution (100 μl) containing 5-methyl-2-hexanone (3.3 μg/ml) and o-cresol (2.3 μg/ml) was added to each vial before vial crimping. SPME was performed using a Gerstel MultiPurpose Robotic PRO (Gerstel, Mülheim Germany) equipped with an SPME fibre (85 μm Carboxen/PDMS, Supelco). The vials were stored on a cooled tray at 10° C. before being incubated at 50° C. for 1 minute. Extraction was done for 30 min at 50° C. with agitation (250 rpm). The fibre was desorbed in the GC inlet (Agilent, 7890) for 30 s. The inlet was equipped with an SPME liner operating at 300° C. with a split ratio of 5:1. Separation was done on a CP-WAX 52B (50 m×0.32 μm×1.2 μm, Agilent CP77731). The oven program started at 70° C. (2 min hold) and then increased at 12° C./min to 240° C. (10 min hold). Helium was used as carrier gas at 2 ml/min (39.4 cm/s). Mass selective detection (Agilent, 5977B) was used for detection. The temperature of the ion source and quadrupole were 230° C. and 150° C., respectively. The mass spectrometer was operated both in scan mode (m/z 29-250) and in selective ion monitoring (SIM) mode with a dwell time of 100 ms for all ions. The monitored ions and start times are shown in table 5.

TABLE 5
Start time and m/z for SIM mode.

| Start time - | | Ion 1 - | Ion 2 - | Ion 3 - | Ion 4 - |
|---|---|---|---|---|---|
| minutes | Analyte | m/z | m/z | m/z | m/z |
| 0.1 | Methylbutanal | 41 | 44 | 57 | 71 |
| 5.2 | 2-butenal, hexanal | 39 | 44 | NA | NA |
| 6.9 | 2-hexene, 5-methyl- | 41 | 58 | 69 | NA |
| | 2-hexanone | | | | |
| 9.0 | Furfural | 67 | 96 | NA | NA |
| 12.1 | Benzaldehyde | 41 | 55 | 106 | NA |
| 13.2 | Phenylacetaldehyde | 91 | 120 | NA | NA |
| 14.5 | Ethylnicotinate | 78 | 106 | NA | NA |
| 16.1 | o-cresol | 90 | 108 | NA | NA |

Analytes were tentatively identified from deconvolution of the chromatograms. Characteristic ions of the analytes were used for peak integration in ChemStation.

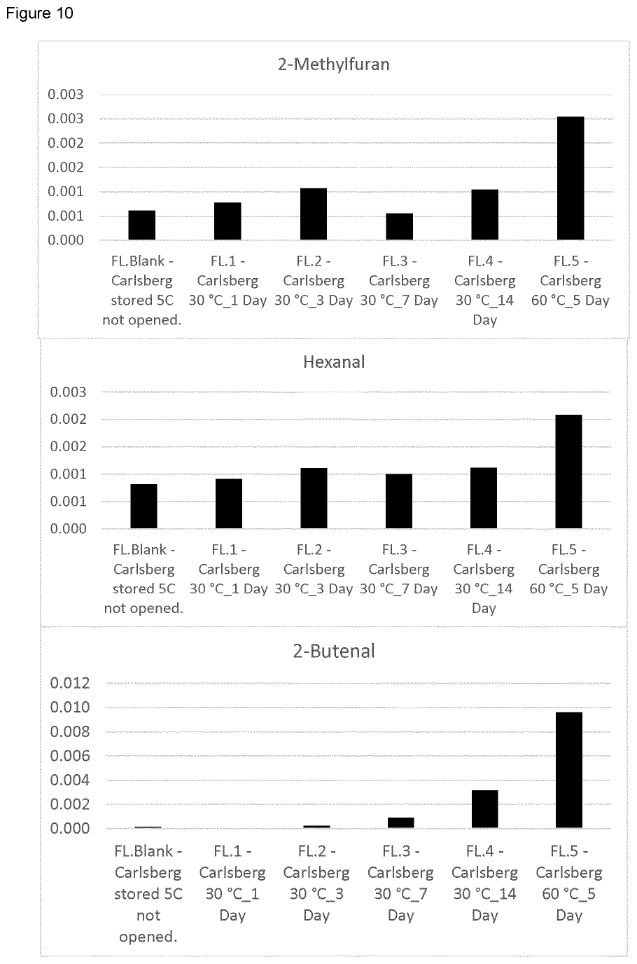

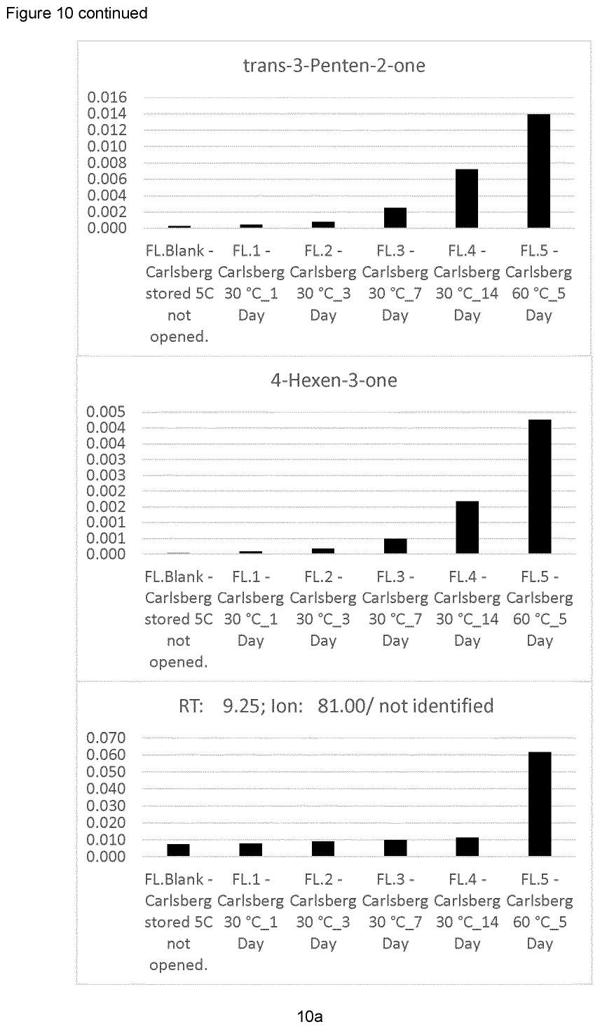

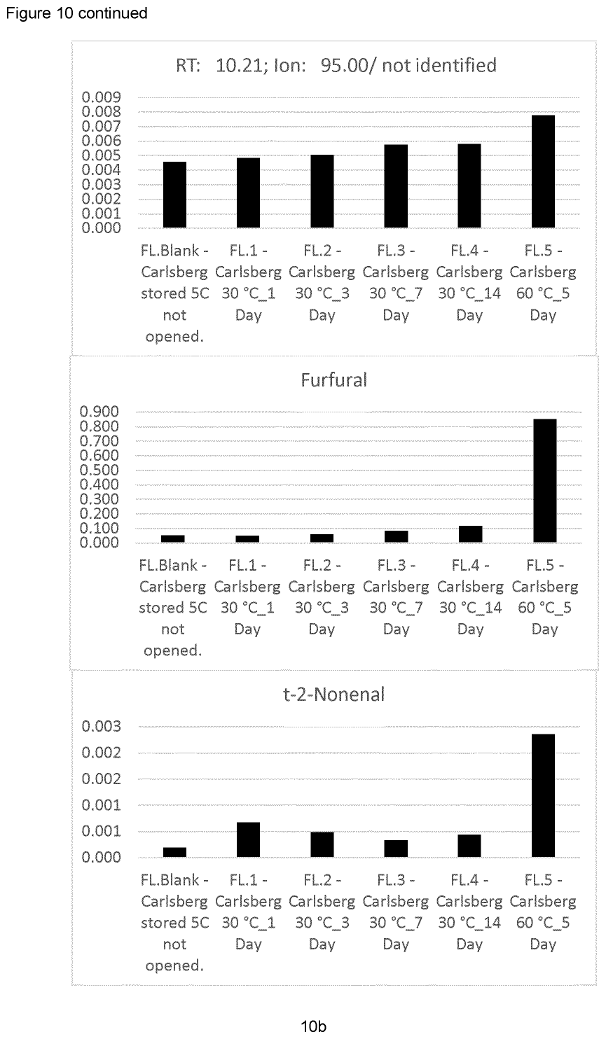

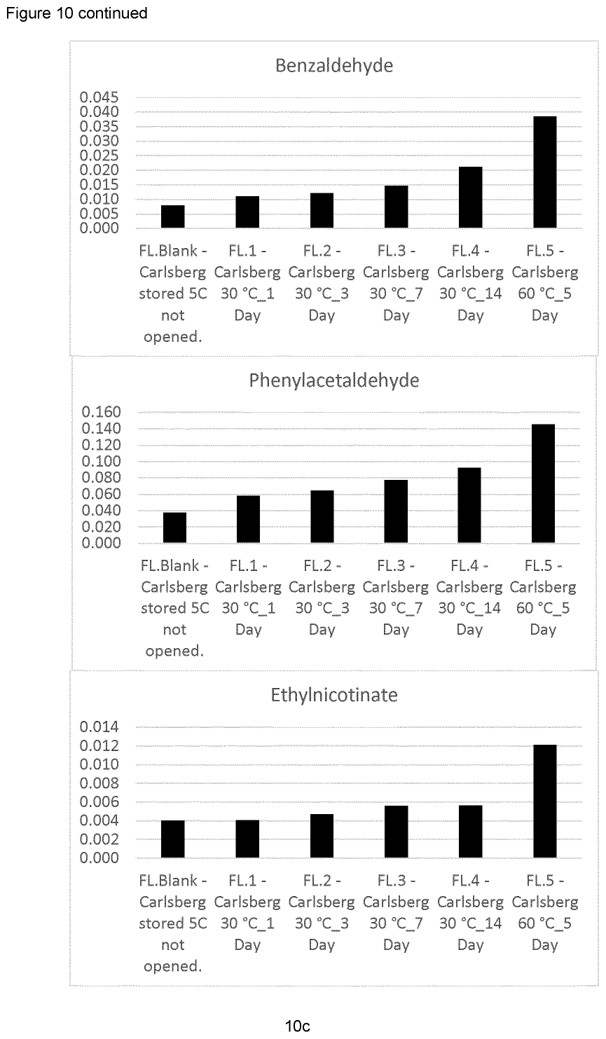

Relative quantification of the following off-flavours was performed: 2-Methylfuran, Hexanal, 2-Butenal, trans-3-Penten-2-one, 4-Hexen-3-one, Furfural, trans-2-Nonenal, Benzaldehyde, Phenylacetaldehyde and Ethylnicotinate, as well as two unidentified substances (ion, RT: 10.21; Ion: 95.00/not identified and RT: 9.25; Ion: 81.00/not identified). The results are shown in FIG. 10—it is clear from these that flushing the headspace of beer bottles with atmospheric air followed by 5 days incubation at 60° C. provided the highest increase in oxidative off-flavour generation. Significant off-flavour was also formed after 14 days at 30° C., however less than 60° C. Gradually decreasing off-flavour was observed with reducing incubation time at 30° C.

### Example 11—Using Catalase to Reduce Off-Flavour Generation in Beer

To investigate the action of catalase on the accelerated Strecker aldehyde and off-flavor generation in beer, various concentration of catalase were added to regular pilsner type beer (Carlsberg, Denmark, 4.6% (v/v) alc.). Off-flavour was quantified as described in example 10, using incubation at 30° C. for 14 days. For comparison, a very potent antioxidant commonly found in beer, sulfite, was added in excess in the form of Sodium Metabisulfite (Na₂S₂O₅). 10 g Sodium Metabisulfite (Na₂S₂O₅, Sigma Aldrich) was dissolved in 100 ml double-diluted H₂O and added to a concentration of 10 ppm SO₂ in the beer. Catalase with SEQ ID NO: 1 from Aspergillus niger or Trichoderma reesei was added according to the below concentrations. The following treatments were used:
O1GC_1_no; control—Carlsberg pilsner stored at RT and not opened
O1GC_4; Carlsberg pilsner_flushed, 30° C. for 14 Days
O1GC_5; Carlsberg pilsner+0.64 U/ml catalase (Aspergillus niger) flushed, 30° C. for 14 Days
O1GC_10; Carlsberg pilsner+29.6 U/ml catalase (Trichoderma reesei) flushed, 30° C. for 14 Days
O1GC_12; Carlsberg pilsner+3.7 U/ml catalase (Trichoderma reesei) flushed, 30° C. for 14 Days
O1GC_16; Days Carlsberg pilsner+10 ppm Sulfite_flushed, 30° C. for 14 Days

The relative amounts of off-flavour generated in beers at 30° C. after 14 days was analyzed as described in example 10, with results shown in table 6. It is clear from the results that addition of catalase significantly decreased off-flavour generation, especially for 2-Butenal, 4-Hexen-3-one, trans-3-Penten-2-one, Benzaldehyde, Phenylacetaldehyde and trans-2-Nonenal. The action of the catalase also exceeding the effect of 10 ppm added sulfite, with this effect most pronounced at increased doses. For all analyzed off-flavours the highest dose of catalase (29.6 U/ml) remarkably showed lower levels of off-flavours compared to the control with no addition. This clearly suggest that catalase can greatly improve oxidative stability, reduce a broad set of off-flavours generated in beer, and therefore extend the shelf-life of the beer.

TABLE 6
Relative GC-MS SPME quantification of selected beer off-flavours in a regular Carlsberg pilsner
(Denmark, 4.6% (v/v) alc.), after head space air flush and incubation at 30° C. for 14 days. The fresh
control was retained at room-temperature (RT) 20-22° C. Catalase and sulfite addition are as indicated.
GC-MS SPME

| | | | O1GC_5 | O1GC_10 | O1GC_12 | O1GC_16 |
|---|---|---|---|---|---|---|
| | O1GC_1_no | | Carlsberg | Carlsberg | Carlsberg | Carlsberg |
| | Control - | O1GC_4 | pilsner + | pilsner + | pilsner + | pilsner + |
| | Carlsberg | Carlsberg | 0.64 U/mL | 29.6 U/mL | 3.7 U/mL | 10 ppm |
| | pilsner | pilsner_{—} | catalase_{—} | catalase_{—} | catalase_{—} | Sulfite_{—} |
| | stored | flushed | flushed | flushed | flushed | flushed |
| | RT not | 30° C. for | 30° C. for | 30° C. for | 30° C. for | 30° C. for |
| results | opened | 14 Days | 14 Days | 14 Days | 14 Days | 14 Days |
| 2-Butenal | 00.01 | 02.08 | 00.07 | 00.04 | 00.08 | 01.09 |
| Hexanal | 00.07 | 03.00 | 02.06 | 02.04 | 02.07 | 02.09 |
| trans-3-Penten- | 00.05 | 15.07 | 02.06 | 01.01 | 03.01 | 09.09 |
| 2-one | | | | | | |
| 4-Hexen-3-one | 00.00 | 05.01 | 01.00 | 00.05 | 01.02 | 03.02 |
| Nonanal | 02.03 | 04.00 | 02.09 | 02.00 | 02.03 | 02.02 |
| Furfural | 72 | 1741 | 1903 | 1767 | 1874 | 1653 |
| Decanal | 00.05 | 00.06 | 00.07 | 00.06 | 00.06 | 00.06 |
| trans-2- | 00.04 | 01.04 | 01.02 | 00.08 | 00.09 | 01.02 |
| Nonenal | | | | | | |
| Benzaldehyde | 14 | 52 | 33 | 25 | 33 | 43 |
| Phenylacetaldehyde | 50 | 180 | 167 | 126 | 161 | 168 |
| Ethylnicotinate | 6 | 22 | 26 | 26 | 22 | 24 |

### Example 12—Beer Freshness Analysis with Multiple Potential Additives for Reducing Free Radicals

330 ml bottles of Carlsberg pilsner (fresh still within best before date) were tested using the following procedure.

With the exception of the O₁FA_1_no control treatment, all beer bottles were opened. The headspace was gently flushed with atmospheric air for 10 s to replace the CO2 contained in it from bottling. This was to ensure oxidation of the beer. Flushing was carried out in an extraction hood to avoid contamination, and done gently to avoid loss of beer. The open beers were then dosed with the additives as listed below in table 7.

All beers were then firmly closed with crown corks, and then turned upside-down to ensure mixing within the bottles of the liquid with the headspace air. All beers were then incubated at 30° C. for 14 days.

After 14 days the beers were placed in a coldroom as until analysis—this provides the final freshness index of each beer sample. A Bruker automated microESR system was used to compare the samples to each other rather. Samples were run in duplicate for preparation and analysis, but were not sensory tested.

TABLE 7

| Sample | Treatment | Additive | Additive dose |
|---|---|---|---|
| O1FA_1_no | Stored | No addition | |
| | cold, not | | |
| | opened | | |
| O1FA_4_no | Stored | Blank (double- | 500 μl of H₂O (double- |
| | cold, no | distilled H₂O) | distilled H₂O) |
| | flush | | |
| O1FA_5_no | Stored | FL001_FoodPro | 211.2 μl of Foodpro CAT |
| | cold, no | CAT (1000 U), EDS | |
| | flush | 953, Catalase A. | |
| | | niger | |
| O1FA_10_no | Stored | FL002_GC119 | 1056 μl of 1 g of GC119 |
| | cold, no | (34000 U), EDS | (34000 U), EDS 980, |
| | flush | 980, Catalase T. | Catalase T. reesei in |
| | | reesei | 10 ml MQ (10x dilution) |
| O1FA_12_no | Stored | FL002_GC119 | 132 μl of 1 g of GC119 |
| | cold, no | (34000 U), EDS | (34000 U), EDS 980, |
| | flush | 980, Catalase T. | Catalase T. reesei in |
| | | reesei | 10 ml MQ (10x dilution) |
| O1FA_16_no | Stored | Sodium | 33 μl of Stock solution: |
| | cold, no | Metabisulfite | 10 g Sodium Metabisulfite |
| | flush | (Na₂S₂O₅, 190.1, | in 100 ml double-distilled |
| | | C12) | H₂O |
| O1FA_22_no | Stored | FL003 Guardian | 550 μl of stock solution: |
| | cold, no | Acerola - Acerola | 30 g Acerola in 100 ml |
| | flush | juice concentrate | double-distilled H₂O, |
| | | for food | ensure complete |
| | | | solubility and |
| | | | homogeneous solution |
| O1FA_28_no | Stored | FL003 Guardian | 550 μl of stock solution: |
| | cold, no | Acerola - Acerola | 30 g Acerola in 100 ml |
| | flush | juice concentrate | double-distilled H₂O, |
| | | for food | ensure complete |
| | | | solubility and |
| | | | homogeneous solution |
| O1FA_4 | Open flush, | Blank (double- | 500 μl of H₂O (double- |
| | 14 days | distilled H₂O) | distilled H₂O) |
| | 30° C. | | |
| O1FA_5 | Open flush, | FL001_FoodPro | 211.2 μl of Foodpro CAT |
| | 14 days | CAT (1000 U), EDS | |
| | 30° C. | 953, Catalase A. | |
| | | niger | |
| O1FA_10 | Open flush, | FL002_GC119 | 1056 μl of 1 g of GC119 |
| | 14 days | (34000 U), EDS | (34000 U), EDS 980, |
| | 30° C. | 980, Catalase T. | Catalase T. reesei in |
| | | reesei | 10 ml MQ (10x dilution) |
| O1FA_12 | Open flush, | FL002_GC119 | 132 μl of 1 g of GC119 |
| | 14 days | (34000 U), EDS | (34000 U), EDS 980, |
| | 30° C. | 980, Catalase T. | Catalase T. reesei in |
| | | reesei | 10 ml MQ (10x dilution) |
| O1FA_16 | Open flush, | Sodium | 33 μl of Stock solution: |
| | 14 days | Metabisulfite | 10 g Sodium Metabisulfite |
| | 30° C. | (Na₂S₂O₅, 190.1, | in 100 ml double-distilled |
| | | C12) | H₂O |
| O1FA_22 | Open flush, | FL003 Guardian | 550 μl of stock solution: |
| | 14 days | Acerola - Acerola | 30 g Acerola in 100 mL |
| | 30° C. | juice concentrate | double-distilled H₂O, |
| | | for food | ensure complete |
| | | | solubility and |
| | | | homogeneous solution |
| O1FA_28 | Open flush, | FL003 Guardian | 550 μl of stock solution: |
| | 14 days | Acerola - Acerola | 30 g Acerola in 100 ml |
| | 30° C. | juice concentrate | double-distilled H₂O, |
| | | for food | ensure complete |
| | | | solubility and |
| | | | homogeneous solution |

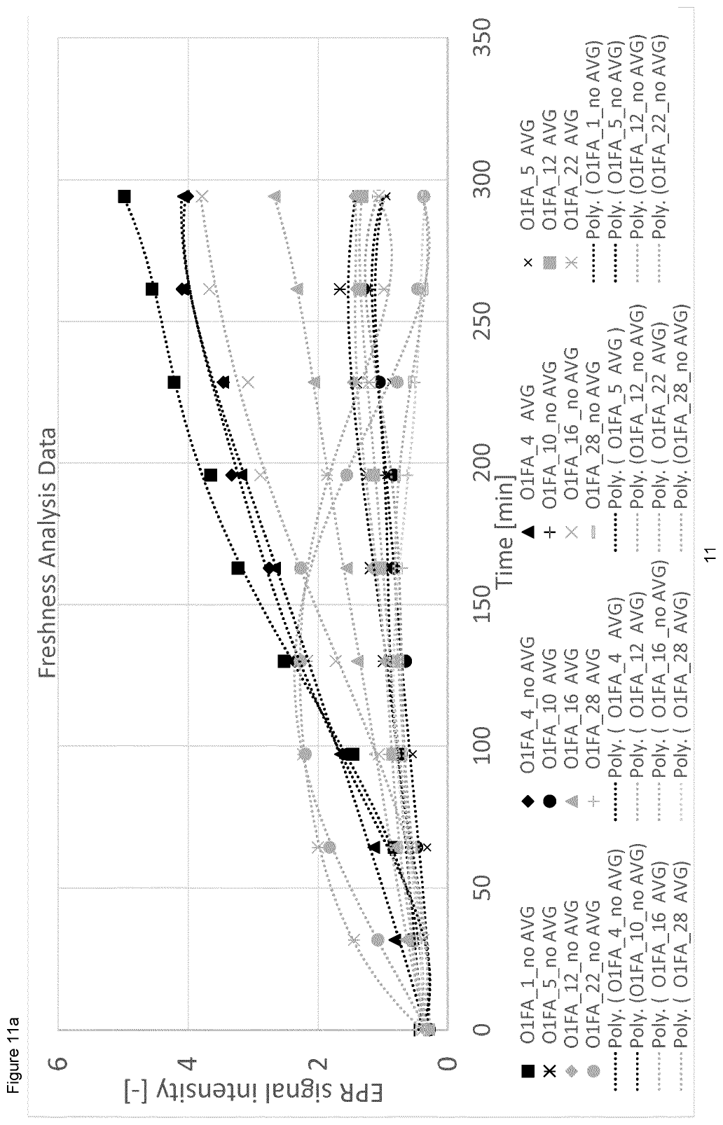

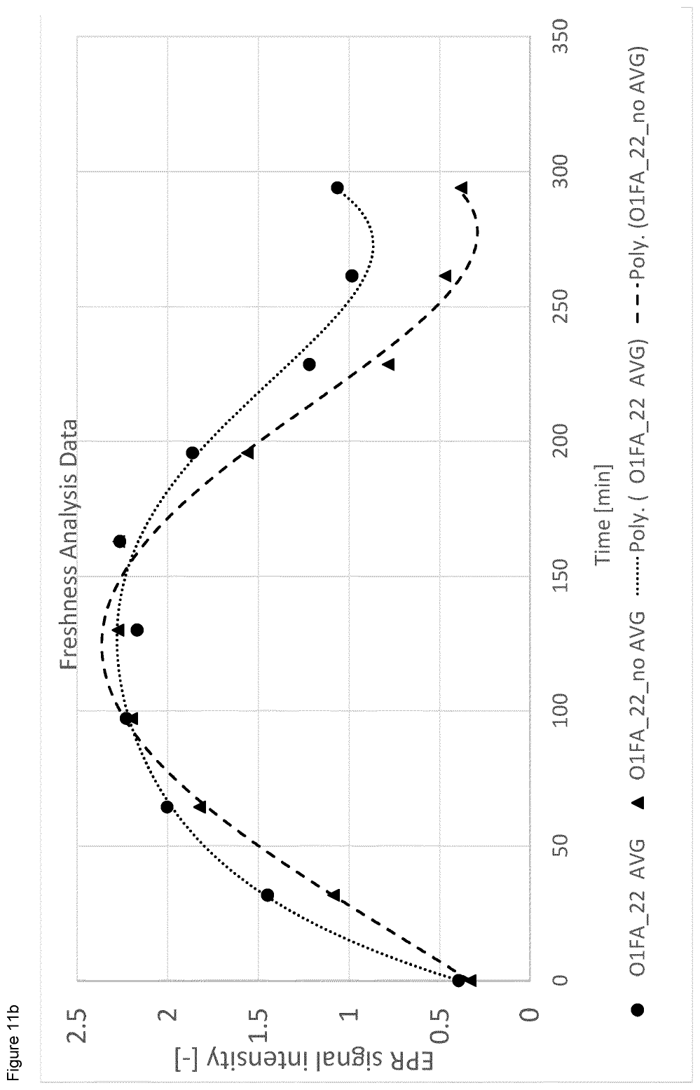

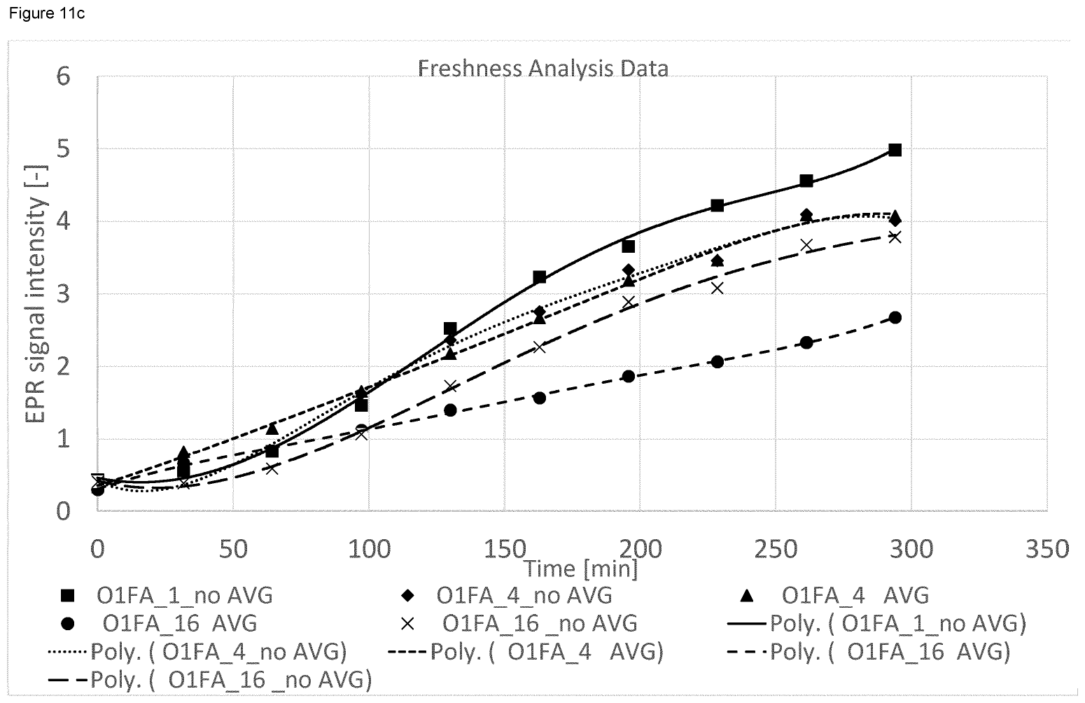

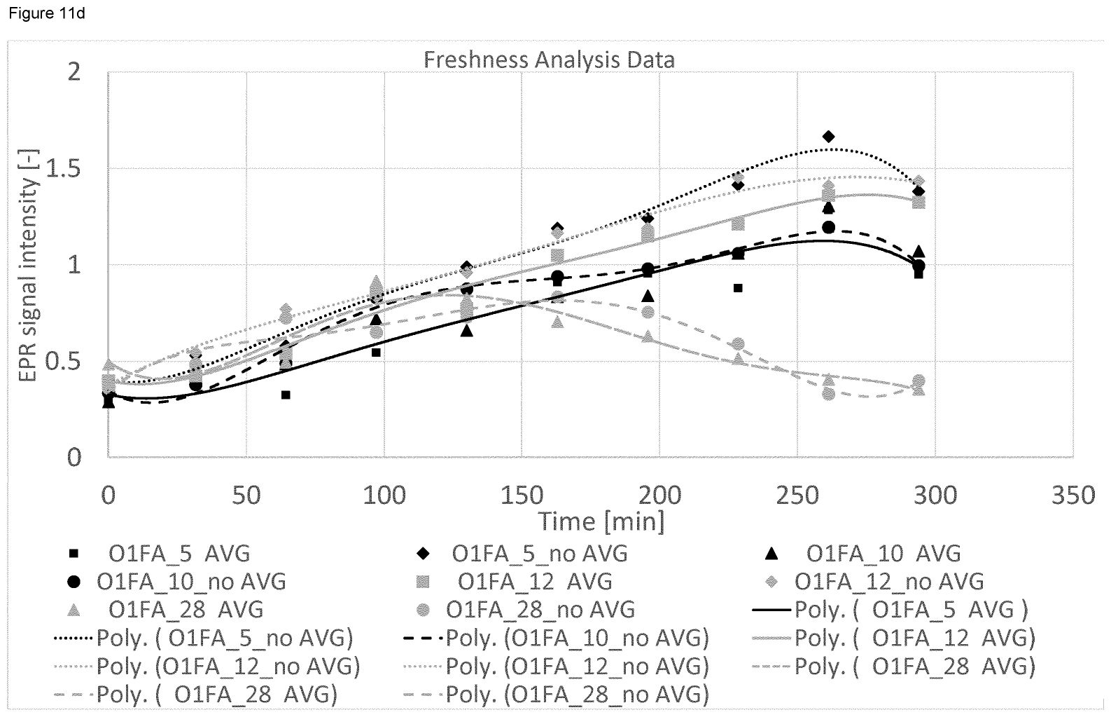

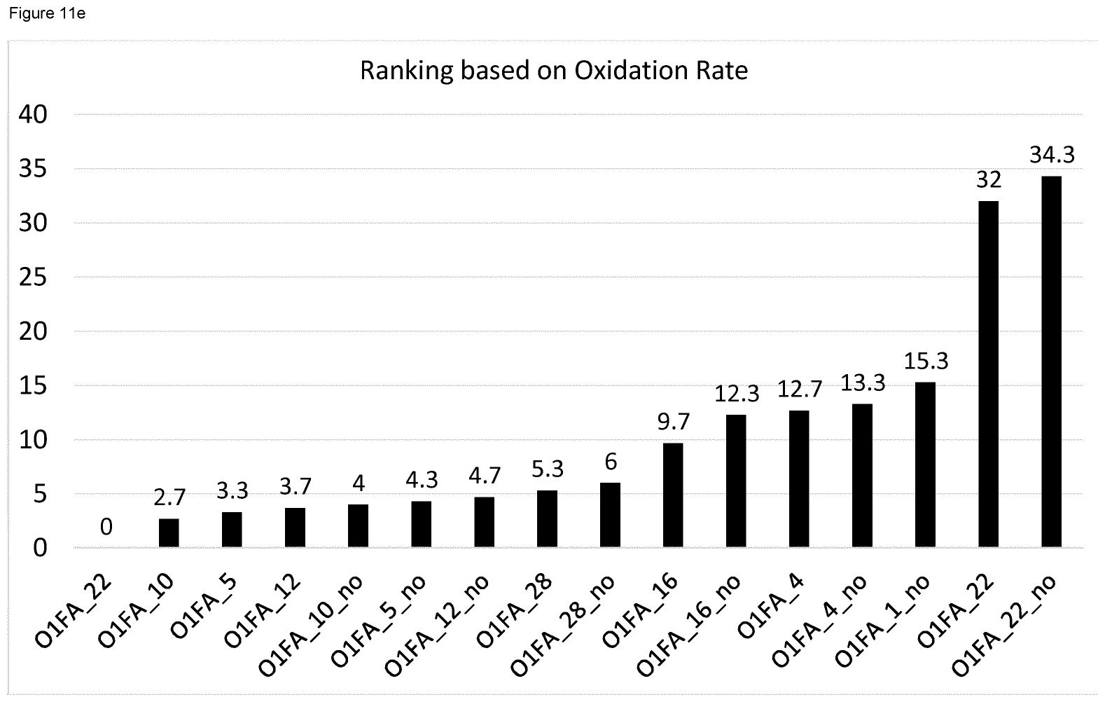

The following measurements were taken for each beer sample, and the results are provided in table 8. Free radical generation results are shown in FIG. 11a, and the same data separated by common trends within sample grouped in FIGS. 11b, 11c and 11d. Oxidation rate is shown in FIG. 11e.

There were very clear differences between the beer sample in terms of their freshness. The majority of samples have either poor freshness/no freshness protection to acceptable protection. However, oxidation is reduced across the sample range. This suggests that fewer free radicals are generated after protection is lost.

TABLE 8

| | Freshness | Oxidation | Oxidation | Oxidation | |
|---|---|---|---|---|---|
| Sample | Index | Index | Capacity | Rate | Comment |
| O1FA_1_no | 41.8 | 2.75 | 131.1 | 15.3 | Average protection, high |
| | | | | | oxidation, average |
| | | | | | oxidation rate. |
| O1FA_4_no | 30.9 | 2.52 | 132.3 | 13.3 | Low |
| | | | | | protection/freshness, |
| | | | | | high oxidation, low |
| | | | | | oxidation rate. Sample |
| | | | | | has average |
| | | | | | performance. |
| O1FA_4 | 16.6 | 2.48 | 139.2 | 12.7 | Low |
| | | | | | protection/freshness, |
| | | | | | acceptable oxidation, low |
| | | | | | oxidation rate. Sample |
| | | | | | has average |
| | | | | | performance. |
| O1FA_5 | 44.4 | 0.8 | 27.9 | 3.3 | Acceptable |
| | | | | | protection/freshness, |
| | | | | | very low oxidation and |
| | | | | | oxidation rate. Sample |
| | | | | | has very good (low) |
| | | | | | oxidation overall, |
| | | | | | improvement on |
| | | | | | freshness required |
| O1FA_5_no | 33.3 | 1.1 | 40.4 | 4.3 | Acceptable |
| | | | | | protection/freshness, |
| | | | | | very low oxidation and |
| | | | | | oxidation rate. Sample |
| | | | | | has very good (low) |
| | | | | | oxidation overall, |
| | | | | | improvement on |
| | | | | | freshness required |
| O1FA_10 | 17.1 | 0.8 | 32.2 | 2.7 | Low |
| | | | | | protection/freshness, |
| | | | | | very low oxidation and |
| | | | | | oxidation rate. Sample |
| | | | | | has very good oxidation |
| | | | | | overall (it is low), |
| | | | | | improvement on |
| | | | | | freshness required |
| O1FA_10_no | 4.1 | 0.92 | 44.7 | 4.0 | Low |
| | | | | | protection/freshness, |
| | | | | | very low oxidation and |
| | | | | | oxidation rate. Sample |
| | | | | | has very good (low) |
| | | | | | oxidation overall, |
| | | | | | improvement on |
| | | | | | freshness required |
| O1FA_12 | 24.4 | 0.96 | 36.4 | 3.7 | Low |
| | | | | | protection/freshness, |
| | | | | | very low oxidation and |
| | | | | | oxidation rate. Sample |
| | | | | | has very good (low) |
| | | | | | oxidation overall, |
| | | | | | improvement on |
| | | | | | freshness required |
| O1FA_12_no | 5 | 1.1 | 50.1 | 4.7 | Low |
| | | | | | protection/freshness, |
| | | | | | very low oxidation and |
| | | | | | oxidation rate. Sample |
| | | | | | has very good (low) |
| | | | | | oxidation overall, |
| | | | | | improvement on |
| | | | | | freshness required |
| O1FA_16 | 0 | 1.51 | 88.6 | 9.7 | Low |
| | | | | | protection/freshness, |
| | | | | | very low oxidation and |
| | | | | | oxidation rate. Sample |
| | | | | | has very good (low) |
| | | | | | oxidation overall, |
| | | | | | improvement on |
| | | | | | freshness required |
| O1FA_16_no | 56.4 | 2.01 | 77.2 | 12.3 | Acceptable |
| | | | | | protection/freshness, |
| | | | | | acceptable oxidation and |
| | | | | | oxidation rate. Sample |
| | | | | | has very good (low) |
| | | | | | oxidation overall, |
| | | | | | improvement on |
| | | | | | freshness required |
| O1FA_22 | 0 | 2.16 | 128.5 | 32.0 | No freshness/protection, |
| | | | | | acceptable oxidation and |
| | | | | | below acceptable |
| | | | | | oxidation rate |
| O1FA_22_no | 0 | 2.07 | 138.2 | 34.3 | No freshness/protection, |
| | | | | | acceptable oxidation and |
| | | | | | below acceptable |
| | | | | | oxidation rate |
| O1FA_28 | 0 | 0.73 | 23.7 | 5.3 | Sample does not show |
| | | | | | any free radical |
| | | | | | generation |
| O1FA_28_no | 0 | 0.76 | 30.9 | 6.0 | Sample does not show |
| | | | | | any free radical |
| | | | | | generation |

Notes for Table 8:
Freshness Index—traditionally called the lag time, or the infection point where the beer's ability to remain fresh has failed and free radicals are being generated. Higher values are favoured for beer.
Oxidation Index—the free radical amount at the 150 minute time point. Lower values are favoured for beer.
Oxidation Capacity—the total oxidation value based on the area within the graph generated. Lower values are favoured for beer.
Oxidation Rate—the measurement of how quickly free radicals are produced once anti-oxidants have been depleted in a beer sample (units - nM/minute). Lower values are favoured for beer.

### Numbered Paragraphs

Aspects of the present invention will now be described by way of numbered paragraphs.

1. A method for producing a beer, wherein said method comprises adding a catalase composition after mash boiling and/or during or after wort preparation and/or fermentation and/or maturation and/or stabilization and/or pasteurization of the beer, and/or comprises adding a catalase composition to the final beer.

2. The method according to paragraph 1, wherein the catalase composition has a catalase activity of at least 0.1 U/ml in the mash boiled preparation and/or in the wort preparation and/or in the fermented preparation and/or in the maturation preparation and/or in the stabilized preparation and/or in the pasteurized preparation and/or in the final beer; and/or wherein the catalase composition provides a catalase activity of at least 0.1 U/ml in to the mash boiled preparation and/or to the wort preparation and/or to the fermented preparation and/or to the maturation preparation and/or to the stabilized preparation and/or to the pasteurized preparation and/or to the final beer.

3. The method according to paragraph 1 or paragraph 2 wherein the catalase is a microbial catalase.

4. The method according to any one of paragraphs 1 to 3 wherein said microbial catalase is derivable from a bacterium or a fungus.

5. The method according to any one of paragraphs 1 to 4 wherein the microbial catalase is derivable from a fungus, preferably from an Aspergillus sp. or Trichoderma sp., preferably A. niger or T. reesei.

6. The method according to any one of paragraphs 1 to 5 wherein said catalase has the sequence of SEQ ID NO: 1, SEQ ID NO: 2, SEQ ID NO: 3, or SEQ ID NO: 4, or a sequence with at least 70% identity thereto.

7. The method according to paragraph 6 wherein said catalase has a sequence with at least 75%, 80%, 85%, 90%, 95%, 96%, 97%, 98%, 99% or 100% identity to SEQ ID NO: 1, SEQ ID NO: 2, SEQ ID NO: 3, or SEQ ID NO: 4.

8. The method according to any one of paragraphs 1 to 7 wherein said catalase is produced by recombinant techniques.

9. The method according to any one of paragraphs 1 to 8, wherein the catalase composition further comprises glucose oxidase.

10. The method according to any one of paragraphs 1 to 19, wherein said catalase is added during maturation and/or stabilization and/or pasteurization of the beer, and/or to the final beer.

11. The method according to any one of paragraphs 1 to 10, wherein a proline-specific protease is added during production of the beer.

12. The method according to any one of paragraphs 1 to 11 wherein the oxidative stability of the beer is improved.

13. The method according to any one of paragraphs 1 to 12 wherein there is a reduction in the generation of Strecker aldehydes in the mash boiled preparation and/or the wort preparation and/or the fermented preparation and/or the maturation preparation and/or the stabilized preparation and/or the pasteurized preparation and/or the final beer.

14. The method according to any one of paragraphs 1 to 13 wherein the generation of Strecker aldehydes in the final beer is reduced.

15. The method according to any one of paragraphs 1 to 14 wherein there is a reduction of trans-2-Nonenal generation in the mash boiled preparation and/or the wort preparation and/or the fermented preparation and/or the maturation preparation and/or the stabilized preparation and/or the pasteurized preparation and/or the final beer.

16. The method according to any one of paragraphs 1 to 15 wherein there is a reduction of trans-2-Nonenal generation in the final beer.

17. The method according to any one of paragraphs 15 to 16 wherein there is at least 10% at least, 20% at least 30%, at least 40%, or at least 50% in trans-2-Nonenal generation, preferably a reduction of at least 50% in trans-2-Nonenal generation.

18. The method according to any one of paragraphs 1 to 17 wherein there is a reduction of trans-Benzaldehyde generation in the mash boiled preparation and/or the wort preparation and/or the fermented preparation and/or the maturation preparation and/or the stabilized preparation and/or the pasteurized preparation and/or the final beer.

19. The method according to any one of paragraphs 1 to 18 wherein there is a reduction of trans-benzaldehyde generation in the final beer.

20. The method according to any one of paragraphs 18-19 wherein there is a reduction of at least 10%, at least 20%, at least 30%, at least 40%, or at least 50% in benzaldehyde generation, preferably a reduction of at least 50% Benzaldehyde generation.

21. The method according to any one of paragraphs 1 to 20 wherein the shelf-life of the beer is extended.

22. The method according to any one of paragraphs 1 to 21 wherein the shelf-life of the beer is extended to at least about 4 months and/or by at least about 4.

23. The method according to any one of paragraphs 1 to 22 wherein the flavour stability of the beer is improved.

24. Use of a catalase in the production of beer, wherein said catalase composition is added after mash boiling and/or during or after wort preparation and/or fermentation and/or maturation and/or stabilization and/or pasteurization, and/or is added to the final beer.

25. The use according to paragraph 24 wherein the catalase composition is in the catalase composition as defined in any one of paragraphs 1 to 23.

26. The use according to any one of paragraphs 24 to 25 wherein the flavour stability of the beer is improved.

27. A beer obtained or obtainable by a method according to any one of paragraphs 1 to 23.

28. The beer according to paragraph 27 wherein said beer comprises catalase.

29. A beer comprising catalase.

30. The beer according to any one of paragraphs 27 to 29 wherein said beer comprises glucose oxidase.

31. The beer according to any one of paragraphs 27 to 30 wherein the shelf-life of the beer is extended to at least about 4 months or is extended by at least about 4 months.

32. The beer according to any one of paragraphs 27 to 31 wherein the flavour stability of the beer is improved.

All publications mentioned in the above specification are herein incorporated by reference. Various modifications and variations of the described methods and system of the invention will be apparent to those skilled in the art without departing from the scope and spirit of the invention.

Although the invention has been described in connection with specific preferred embodiments, it should be understood that the invention as claimed should not be unduly limited to such specific embodiments. Indeed, various modifications of the described modes for carrying out the invention which are obvious to those skilled in biochemistry, molecular biology or related fields are intended to be within the scope of the following aspects.

SEQUENCES

SEQ ID NO: 1 (sets forth the mature amino acid sequence of the catalase from Aspergillus
niger):
QCPYLSGEMSFTQEQDNAGDTIEVTEQPIDNTLYVNDTGSYMTTDFGTPISDQTSLKAGPRGP
TLLEDFIFRQKLQRFDHERVPERVVHARGAGAYGTFKSYADWSNVTAADFLSANDKETPMFCR
FSTVVGFRGSVDTARDVHGHACRFYTDEGNYDIVGINFAPFFIQDAIQFPDLVHAIKPMPNNEIP
QAATAHTSAWDFFSQQSTALHSALWLMSGNGIPRSFRHMNGYGVHSFRFVAANGTSKVVRY
RWKSQQGVASLVWDEAQAAAGKNSDYHRQDLYNAIANGHYPKYELQAQIMDEADMLRFGFD
LLDPTKLVPEEVVPYTPLGMMELNANPTNYFAEVEQAGFQPGHVVPGIDFTDDPLLQGRLFSY
LDTQLTRHGGPNFEQIPVNRPRKPVHNNNRDGFGQQQIPTNNWAYTPNSMSNGYPMQANQT
QGHGFFTAPYRYASGHLVRQTSPTFNDHWSQPAMFWNSLIPAEQQMVVNAIVFENSKVNSPH
VRKNVVNQLNMVNNNLAVRVARGLGLDEPSPNPTYYTSNKTSNVGTFGKPLLSIEGLQVGFLA
SNSHPESIKQGQAMAAQFSAAGVDLNIVTEAYADGVNTTYALSDAIDFDALIIADGVQSLFASPA
LANQMNSTATSTLYPPARPFQILVDSFRYGKPVAAVGSGSVALKNAGIDSSRSGVYTGSSETTE
KIAKEVLEGLYTFRFVDRFALDE
SEQ ID NO: 2 (sets forth the putative amino acid sequence of the catalase from Aspergillus
niger, with the potential truncated N-terminal region cleaved off underlined and in bold):
MRHFWLLPAVAGIAGAQCPYLSGEMSFTQEQDNAGDTIEVTEQPIDNTLYVNDTGSYMTTDF
GTPISDQTSLKAGPRGPTLLEDFIFRQKLQRFDHERVPERVVHARGAGAYGTFKSYADWSNVT
AADFLSANDKETPMFCRFSTVVGFRGSVDTARDVHGHACRFYTDEGNYDIVGINFAPFFIQDAI
QFPDLVHAIKPMPNNEIPQAATAHTSAWDFFSQQSTALHSALWLMSGNGIPRSFRHMNGYGV
HSFRFVAANGTSKVVRYRWKSQQGVASLVWDEAQAAAGKNSDYHRQDLYNAIANGHYPKYE
LQAQIMDEADMLRFGFDLLDPTKLVPEEVVPYTPLGMMELNANPTNYFAEVEQAGFQPGHVVP
GIDFTDDPLLQGRLFSYLDTQLTRHGGPNFEQIPVNRPRKPVHNNNRDGFGQQQIPTNNWAYT
PNSMSNGYPMQANQTQGHGFFTAPYRYASGHLVRQTSPTFNDHWSQPAMFWNSLIPAEQQ
MVVNAIVFENSKVNSPHVRKNVVNQLNMVNNNLAVRVARGLGLDEPSPNPTYYTSNKTSNVG
TFGKPLLSIEGLQVGFLASNSHPESIKQGQAMAAQFSAAGVDLNIVTEAYADGVNTTYALSDAID
FDALIIADGVQSLFASPALANQMNSTATSTLYPPARPFQILVDSFRYGKPVAAVGSGSVALKNA
GIDSSRSGVYTGSSETTEKIAKEVLEGLYTFRFVDRFALDE
SEQ ID NO: 3 (sets forth the putative amino acid sequence of the catalase expressed from
Aspergillus niger):
SNGIE ASLLT DPKDV SGRTV DYIIA GGGLT GLTTA ARLTE NPNIS VLVIE
SGSYE SDRGP IIEDL NAYGD IFGSS VDHAY ETVEL ATNNQ TALIR SGNGL
GGSTL VNGGT WTRPH KAQVD SWETV FGNEG WNWDN VAAYS LQAER ARAPN
AKQIA AGHYF NASCH GVNGT VHAGP RDTGD DYSPI VKALM SAVED RGVPT
KKDFG CGDPH GVSMF PNTLH EDQVR SDAAR EWLLP NYQRP NLQVL TGQYV
GKVLL SQNGT TPRAV GVEFG THKGN THNVY AKHEV LLAAG SAVSP TILEY
SGIGM KSILE PLGID TVVDL PVGLN LQDQT TATVR SRITS AGAGQ GQAAW
FATFN ETFGD YSEKA HELLN TKLEQ WAEEA VARGG FHNTT ALLIQ YENYR
DWIVN HNVAY SELFL DTAGV ASFDV WDLLP FTRGY VHILD KDPYL HHFAY
DPQYF LNELD LLGQA AATQL ARNIS NSGAM QTYFA GETIP GDNLA YDADL
SAWTE YIPYH FRPNY HGVGT CSMMP KEMGG VVDNA ARVYG VQGLR VIDGS
IPPTQ MSSHV MTVFY AMALK ISDAI LEDYA SMQ
SEQ ID NO: 4 (sets forth the putative amino acid sequence of the catalase expressed from
Trichoderma reesei):
MAEKPLHLDLIDTLKDVSVRVDHVRPSHAKGVFVIGSFTPTKEAGQLSTAPHFNSPSTPVVARF
SLFTGFPDLPSNDPQAVPHGLAVRFLIGDGVKSDIVCHSTPLFPANTGEGVLAVFKALRDNIVEE
YLSTHPEAIPFFTEDRKTPEHWGTQTFYSINAFKFVNAEGKSVFVRYRWVPVAGRHFLTEKELE
AKGPNFLFNELPEVFAKGPIIFKLVAQVAEEGDVTGDCMQRWPEDRKLVELGELKLTRVADKQ
DLPPQKEAISYNVIPGVPGIEPSDDPIIATRGKVYATSGQTRRAAEIEAEA
SEQ ID NO: 5:
MVPSRRILVTLALVAAPWPPQVLASSTDSYDYIIVGAGTCGLLLANRLSQDANYTVAIID
PGADERDNPNVVDPLGWLGLTGTSVYWNYSSIPQEKLGGRVLEYDAGRGIGGTSLINGMT
YIRGDKAQFDAWEQLGNPGWNWTTMLKHFKKIEQFFPPLPWQETAGALYEDEYHGTSGEM
HVGFNPALLSGSFYGDVKASWAALGQTLNRDASSGDTAGFDVWPQTLDPVKNVRWDAATA
FYWPVQDRPNLALLNGTVSRILWKNDEADVPEASGVEYLTPDGNIKTVNARREVILSAGA
LRTPLILELSGIGNPSILNGLGIETVVNSPGVGENLIDQSNVALTYSTKESFPGYAPYAT
FVNATSLFGDGVEALAASTKKSLPIWAQQIAAQTNGVISARAIEHRLQVQHDLIFKKGVT
IAEILSSASGTTAISAYWDTLPFSRGSVHLSSANDINTPAINPRFLSVDFDLAVQVAVGR
LATKFWTTAPISAVIEARVDPNSTILPDNATDAQWEDFTRSSLISNSHSLGTAAMMKREW
GGVVDSQMRVYGTGNVRVVDASVLPMQVSGHLTATLYAVAERAGEMIVGDRSGL
SEQ ID NO: 6 (Aspergillus niger):
MQTFGAFLVSFLAASGLAAAARPRLVPKPISRPASSKSAATTGEAYFEQLLDHHNPEKGTFSQR
YWWSTEYWGGPGSPVVLFNPGEVSADGYEGYLTNDTLTGVYAQEIQGAVILIEHRYWGDSSP
YEVLNAETLQYLTLDQSILDMTYFAETVKLQFDNSSRSNAQNAPWVMVGGSYSGALTAWTESI
APGTFWAYHATSAPVEAIYDFWQYFYPIQQGMAQNCSKDVSLVAEYVDKIGKNGTAKEQQELK
ELFGLGAVEHYDDFAAVLPNGPYLWQDNDFVTGYSSFFQFCDAVEGVEAGAAVTPGPEGVGL
EKALANYANWFNSTILPNYCASYGYWTDEWSVACFDSYNASSPIFTDTSVGNPVDRQWEWFL
CNEPFFWWQDGAPEGTSTIVPRLVSASYWQRQCPLYFPEVNGYTYGSAKGKNSATVNSWTG
GWDMTRNTTRLIWTNGQYDPWRDSGVSSTFRPGGPLVSTANEPVQIIPGGFHCSDLYMEDYY
ANEGVRKVVDNEVKQIKEWVEEYYA
SEQ ID NO: 7 (Aspergillus transmontanensis):
MQFLPPLSIVTLLASWPSLSRAIHPPRPVPPPVSRPVSTQSLAVEGNATFEQLLDHHDSSKGTF
SQRYWWSTEYWGGPGSPVVLFTPGEASADGYEGYLTNNTLTGLYAQEIQGAVILIEHRYWGD
SSPYEELTAETLQYLTLEQSILDLTHFAETVQLEFDTSNSSNAPKAPWVLVGGSYSGALAAWTA
AVAPETFWAYHATSAPVQAIDDFWQYFDPIRHGMAPNCSRDVSLVANHIDTVGKNGSAADQF
ALKELFGLEALEHYDDFAAALPTGPYLWQSNTFVTGYSDFFAFCDAVENVEAGAAVVPGPEGV
GLQKALTGYANWFNSTILPGYCASYGYWTDNRTVACFDTHNPSSAIFIDTSVDNAVDRQWQW
FLCNEPFFWWQDGAPEGVPTIVPRTINAEYWQRQCSLYFPEVNGYTYGSAKGKTAASVNSWT
GGWSDSKNTSRLLWVNGQYDPWRDSGV
SSTHRPGGPLASTADEPVQIIPGGFHCSDLYIKDYYANAGVKQVVDNAVAQIKSWVAEYYK
SEQ ID NO: 8 (Aspergillus homomorphus):
MRFCSPVSVVAVTALWASLTAALRPPRLAPRPVTATTQSAVVESTFEQLIDHNDPSKGTFSQR
YWYSTQYWGGPGSPVVLFTPGEAAADGYGGYLTNRTLTGVYAQQLQGAVVLIEHRYWGGSS
PYANLTAETLQYLTLEQSVLDLTYFAENVQLGFAKNSTSSNAPHVPWVLVGGSYSGALTAWTE
HLAPGTFWAYHATSAPMESIYDFWTYFRPIQEGMAKNCSKDVSLVAEHVDKVGKLGTKAQQK
ALKKLFGLEALEHFDDFAAVLPIGPYLWQDNSFATGYSGFFAFCDAVENVEAGAAVTPGAEGV
GLEKALKGYANWFKNKILPDYCASTYGYWSDKYTVACFDTYNATSPLFRDTSVRNAVDRQWT
WFLCNEPFFWWQDGAPESETSLIPRLVSADYWQRQCSLYFPEVNGYTYGSAKGKTASTFNA
WTDGWFLTGNSTRLIWTNGQYDPWRDAGVSSIFRPGGPLVSTPNEPVQIIPGGFHCSDLYISD
AEVNAGVKKVVINEVAQIKAWVAEFYA
SEQ ID NO: 9 (Rasamsonia emersonii):
MRAVQLLPSLAGLIGAASAVGCPYLTGQLDGREVHNPHEFQRRQDSGDAAASTEQFLSQFYL
NDNNSYMTTDVGGPISDQNSLRAGERGPTLLEDFIFRQKIQHFDHERVPERAVHARGAGAHGT
FTSYGNWSNITAASFLSAEGKETPVFVRFSTVAGSRGSSDTARDVHGFATRFYTDEGNFDIVG
NNIPVFFIQDAILFPDLIHAVKPSPENEIPQAATAHDSAWDFFSQQPSALHTVFWAMSGHGIPRS
FRHMDGFGVHTFRFVTDDGSSKLVKFHWTSLQGRAGLVWEEAQAAAGKNLDYMRQDLYDNI
EAGRYPEWELGVQIVDEEDQLKFGFDLLDPTKILPVEYVPITPLGKLQLNRNPLNYFAETEQIMF
QPGHIVRGIDFTEDPLLQGRLFSYLDTQLNRNGGPNFEQLPINRPRVPFHNNNRDGASQAFIPL
NKAAYSPNTLNNGNPKQANQTVGDGFFTTPGRTASGRLLRAVSSTFSDVWSQPRLFYNSLVP
AEQQFLINAIRFENSNVKSEVVRKNVITQLNRVDNDLARRVARAIGVEEPEPDPTYYHNNKTAN
VGTFGTPLKRIDGLKVGVLATVGDPDSISQGQSLSDTLSDSNVVVTVVAESFTDGVDALYTNSD
ATNFDAVIVADGAEGLFAPSSFTAQPTNSSSTASLYPAGRPLQILVDAFRFGKPVGALGSGSKA
LDAAGISKSRPGVYVANSISEAFTDAIEDGLRTFKFLDRFALDE
SEQ ID NO: 10 (Penicillium antarcticum):
MHALALFTGLVGVANAACPYMTGDIADSPHSIERRNDGDAAATEEFLSQFYLNDEDTYLTSDV
GGPIEDQNSLKAGERGPTLLEDFIFRQKIQRFDHERVPERAVHARGTGAHGTFTSYGDWSNLT
AASFLSAKGKQTPMFTRFSTVAGSRGSADTARDVHGFATRFYTEEGNFDIVGNNIPVFFIQDAIL
FPDLIHAVKPRGDNEIPQAATAHDSAWDFFSQQPSALHTLLWAMAGHGIPRSFRHVDGFGVHT
FRMVTDKGASKLVKFHWKGMQGKASFVWEEAQQAAGKNADFMRQDLFEAIEAGRFPEWELG
VQIMDEEDQLRFGFDLFDPTKIVPEELVPVTKLGKMQLNRNPMNYFAETEQAMFQPGHIVRGID
FTEDPLLQGRIFSYLDTQLNRHGGPNFEQLPINRPRVPIHNNNRDGAGQMFIPLNKYAYTPNTP
NSGSPKQANQTVGNGFFTSPDRTTTGHLTRSKSSTFEDVWSQPRLFWNSLVPAEKQFVVDA
MRFENSNVKSEVVRNNVIIQLNRISNDLAKRVASAIGVDAPEPDSTFYHDNTTAHIGAFGQKLTK
LDGLKVGLLASVANASSIQQGAKLQSALKSAGVDVVVVAERMADNVNQTYSASDAVQFDAVVI
ADGAEGLFSSRSFTGSPKNKGSGATSLYPAGRPLDILLDAFRFGKPVAAVGGGSAALRAGLISA
EREGVYVGKSVGEEFVKDVKEGLKTFKFLDRFALDE
SEQ ID NO: 11 (Penicillium oxalicum):
MRAVGLVTGLIGIANAACPYMTGETAGLDRRGEKDAASGTEEFLSEFYLKDDENVFLTSDVGG
PIEDQNSLKAGERGPTLLEDFIFRQKIQRFDHERVPERAVHARGAGAHGVFTSYGDWSNITAAS
FLSAKGKETPMFVRFSTVAGSRGSADTARDVHGFATRFYTDEGNFDIVGNNIPVFFIQDAIKFP
DLIHAVKPRGDNEIPQAATAHDSAWDFFSQQPSSLHTLLWAMAGHGIPRSFRHVDGFGVHTYR
LVTDKGDTKLVKFHWKGLQGKASLVWEEAQQVSGKNGDFMRQDLFDAIEAGRYPEWELGVQI
MEEDDQLRFGFDLLDPTKIVPEELVPVVKLGKMTLNRNPMNYFAETEQVMFQPGHIVRGVDFT
DDPLLQGRIYSYLDTQLNRHGGPNFEQIPINRPRVPIHNNNRDGAGQMYIPLNPNAYSPNTLNK
GSPKQANETVGKGFFTAPGRTSSGKLLRAVSSTFEDVWSQPRLFWNSLVPAEQQFVVDAMRF
ENANVMSQVVRNNVVIQLNRISNDLAKRVAEAIGVDAPQPDPTYYHDNTTANIGAFGQKLKKLE
GLKVGVLASVANASSISQGAALQSQLKDVGVDVVVVGERMAHGVNQTYSASDAINFDAVIVAD
GAEGLFSTSSSTVSPKAKSSGATSLYPAGRPMDILLDAFRFGKPVGSLGQGSVALENAQISSD
RDGVYAAKSVDKDFGDKVKEGLRTFKFLDRFALDE
SEQ ID NO: 12 (Aspergillus awamori):
MRPIGLVGLIGLANAACPYMSRDLSPRDSSDASESTEEFLSQYYLNDNNTYLTSDVGGPIEDQN
SLSAGERGPTLLEDFIFRQKIQRFDHERVPERAVHARGVGAHGVFVSYGDFSNLTAASFLSEQ
GKETPMFVRFSTVAGSRGSTDLARDVHGFATRFYTDEGNFDLVGNNIPVFFIQDAIQFPDLIHA
VKPRGDSEIPQAATAHDSAWDFFSQQPSALHTLFWAMAGHGIPRSFRHVDGFGVHTYRLVTD
SGASKLVKFHWKSLQGKASMVWEEAQQVSGKNSDFMRQDLWTSIEYGRYPEWELGVQIMDE
EDQLRFGFDLFDPTKIVPEEYVPITKLGKMTLNRNPLNYFAETEQVMFQPGHIVRGVDFTEDPL
LQGRLFSYLDTQLNRHGGPNFEQLPINQPRVPIHNNNRDGAGQMFIPLNPNAYSPNTLNSASP
KQANQTTGNGFFTSPGRTTSGHLLRSTSPTFQDVWSQPRLFYNSLVPTEQQFLIDAIRFETSNV
KSTTVRQNVIIQLNRISNDLARRVARAIDVPAPDPDPTYYHDNKTADVGTFGTKLKKLSNLRVGF
LASVQTPSSITAAQDLATELKDDEVDVVVVAERLTDGVDQTYSASDAIQFDAVIVAPGAEGLFAS
GSVTAPQLNSTASAVSTLYPAGRPLQVLVDAFRFGKTVGAVGSGEGALRNAGIDDEREGVVV
GQTIGADFVDSVREGLRTFRFLDRFALDEE
SEQ ID NO: 13 (Aspergillus bertholletius):
MHFLAPLSVVTLLASWPLLGYAIHPPKPVPPPVSRPVSTRSSAVVGEATFDQLLDHHDSSKGTF
SQRYWWSTEYWGGPGSPVVLFTPGEASADGYQGYLTNTTLTGRYAQEIQGAVILIEHRYWGG
SSPYKELTAETLQYLTLEQSILDLTYFAETVSLEFDPSNRSNAPKAPWVLVGGSYSGALAAWTA
AVAPETFWAYHATSAPVEAINDFWQYFDPIRQGMAPNCSRDVSLVATHIDRVGKHGSAAEQLA
LKELFGLGAVEHYDDFAAALPIGPYKWQSNTFVTGYSGFFAFCDAVENVKAGATVVPGPEGVG
LQKALRGYAKWFKSTILPGYCANYGYWTDNQTVACFDTYNPSSAIFTDTSVDNAVDRQWQWF
LCNEPFFWWQDGAPEGIPTIIPRTVNAAYWQRQCSLYFPEVNGYTYGSAKGKTAATVNQWTG
GWSATRNTSHLLWVNGQYDPWRDSGVSSIYRPGGPLKSTADEPVQVIPGGFHCSDLYLKDYY
ANDGVKQVIDNAVAQIKSWVAEYYN

1. A method for producing a beer, wherein said method comprises adding a catalase composition after mash boiling and/or during or after wort preparation and/or fermentation and/or maturation and/or stabilization and/or pasteurization of the beer, and/or comprises adding a catalase composition to the final beer.

2. The method of claim 1, wherein the catalase composition has a catalase activity of at least 0.1 U/ml in the mash boiled preparation and/or in the wort preparation and/or in the fermented preparation and/or in the maturation preparation and/or in the stabilized preparation and/or in the pasteurized preparation and/or in the final beer; and/or wherein the catalase composition provides a catalase activity of at least 0.1 U/ml in to the mash boiled preparation and/or to the wort preparation and/or to the fermented preparation and/or to the maturation preparation and/or to the stabilized preparation and/or to the pasteurized preparation and/or to the final beer.

3. The method of claim 2 wherein the catalase is a microbial catalase.

4. The method of claim 3 wherein the catalase is a microbial catalase, wherein said microbial catalase is derivable from a bacterium or a fungus.

5. The method of claim 4 wherein the catalase is a microbial catalase, wherein the microbial catalase is derivable from a fungus, preferably from an Aspergillus sp. or Trichoderma sp., preferably A. niger or T. reesei.

6. The method of claim 5 wherein said catalase has the sequence of SEQ ID NO: 1, SEQ ID NO: 2, SEQ ID NO: 3, or SEQ ID NO: 4, or a sequence with at least 70% identity thereto.

7. The method of claim 6 wherein said catalase has a sequence with at least 75%, 80%, 85%, 90%, 95%, 96%, 97%, 98%, 99% or 100% identity to SEQ ID NO: 1, SEQ ID NO: 2, SEQ ID NO: 3, or SEQ ID NO: 4.

8. The method of claim 7 wherein said catalase is produced by recombinant techniques.

9. The method of claim 8, wherein the catalase composition further comprises glucose oxidase.

10. The method of claim 19, wherein said catalase is added during maturation and/or stabilization and/or pasteurization of the beer, and/or to the final beer.

11. The method of claim 10, wherein a proline-specific protease is added during production of the beer.

12. The method of claim 11 wherein the oxidative stability of the beer is improved.

13. The method of claim 12 wherein there is a reduction in the generation of Strecker aldehydes in the mash boiled preparation and/or the wort preparation and/or the fermented preparation and/or the maturation preparation and/or the stabilized preparation and/or the pasteurized preparation and/or the final beer.

14. The method of claim 13 wherein the generation of Strecker aldehydes in the final beer is reduced.

15. The method of claim 14 wherein there is a reduction of trans-2-Nonenal generation in the mash boiled preparation and/or the wort preparation and/or the fermented preparation and/or the maturation preparation and/or the stabilized preparation and/or the pasteurized preparation and/or the final beer.

16. The method of claim 15 wherein there is a reduction of trans-2-Nonenal generation in the final beer.

17. The method of claim 16 wherein there is at least 10% at least, 20% at least 30%, at least 40%, or at least 50% in trans-2-Nonenal generation, preferably a reduction of at least 50% in trans-2-Nonenal generation.

18. The method of claim 17 wherein there is a reduction of trans-Benzaldehyde generation in the mash boiled preparation and/or the wort preparation and/or the fermented preparation and/or the maturation preparation and/or the stabilized preparation and/or the pasteurized preparation and/or the final beer.

19. The method of claim 18 wherein there is a reduction of trans-benzaldehyde generation in the final beer.

20. The method of claim 19 wherein there is a reduction of at least 10%, at least 20%, at least 30%, at least 40%, or at least 50% in benzaldehyde generation, preferably a reduction of at least 50% Benzaldehyde generation.

21. The method of claim 20 wherein the shelf-life of the beer is extended.

22. The method of claim 21 wherein the shelf-life of the beer is extended to at least about 4 months and/or by at least about 4.

23. The method of claim 22 wherein the flavour stability of the beer is improved.

24. (canceled)

25. (canceled)

26. (canceled)

27. A beer obtained or obtainable by the method of claim 1.

28. The beer according to claim 27 wherein said beer comprises catalase.

29. A beer comprising catalase.

30. The beer of claim 29 wherein said beer further comprises glucose oxidase.

31. The beer of claim 30 wherein the shelf-life of the beer is extended to at least about 4 months or is extended by at least about 4 months.

32. The beer of claim 31 wherein the flavour stability of the beer is improved.
